(19) United States
(12) Patent Application Publication
(10) Pub. No.: US 2005/0033582 A1
(43) Pub. Date: Feb. 10, 2005

(54) Spoken language interface

(76) Inventors: Michael Gadd, Wisborough Green (GB); Keiron Trott, Barcelona (ES); Heung Wing Tsui, London (GB); Mark Stairmand, Reading (GB); Mark Lascelles, London (GB); David Horowitz, London (GB); Peter Lovatt, Harpenden (GB); Peter Phelan, London (GB); Kerry Robinson, Egham (GB); Gordon Sim, Glasgow (GB)

Correspondence Address: ROSENTHAL & OSHA L.L.P., Suite 2800, 1221 McKinney Street, Houston, TX, 77010, US

(21) Appl. No.: 10/649,336

(22) Filed: Aug. 27, 2003

Related U.S. Application Data
(63) Continuation of application No. PCT/GB02/00878, filed on Feb. 28, 2002.

(30) Foreign Application Priority Data
Feb. 28, 2001 (GB) 0105005.3

(51) Int. Cl. G10L 11/00

(52) U.S. Cl. 704/277

(57) ABSTRACT

A spoken language interface comprises an automatic speech recognition system and a text to speech system controlled by a voice controller. The ASR and TTS are connected to a telephony system which receives user speech via a communications link. A dialogue manager is connected to the voice controller and provides control of dialogue generated in response to user speech. The dialogue manager is connected to application managers each of which provide an interface to an application with which the user can converse. Dialogue and grammars are stored in a database as data and are retrieved under the control of the dialogue manager and a personalisation and adaptive learning module. A session and notification manager records session details and enables re-connection of a broken conversation at the point at which the conversation was broken.

This application is a continuation application of PCT Application Number PCT/GB02/00878, filed Feb. 28, 2002, which claims priority from United Kingdom Application Serial No. 0105005.3, filed Feb. 28, 2001.

### BACKGROUND OF INVENTION

This invention relates to spoken language interfaces (SLI) which allow voice interaction with computer systems, for example over a communications link.

Spoken language interfaces have been known for many years. They enable users to complete transactions, such as accessing information or services, by speaking in a natural voice over a telephone without the need to speak to a human operator. In the 1970's a voice activated flight booking system was designed and since then early prototype SLIs have been used for a range of services. In 1993 in Denmark a domestic ticket reservation service was introduced. A rail timetable was introduced in Germany in 1995; a consensus questionnaire system in the United States of America in 1994; and a flight information service by British Airways PLC in the United Kingdom in 1993.

All these early services were primitive; having a limited functionality and a small vocabulary. Moreover, they were restricted by the quality of the Automated Speech Recognisers (ASRs) they used. As a result, they were often highly error prone and imposed unreasonable constraints on what users could say. The British Airways system was restricted to staff use only due to the inaccuracy of the automated speech recognition.

More recently, there has been an increase in the use of SLIs to access web-based information and services. This has been due partly to improvements in ASR technology and the widespread use of mobile telephones and other mobile devices. Several companies offer SLIs that provide access to stock market quotes, weather forecasts and travel news. Voice activated e-mail capabilities and some banking services are also available. The following discussion considers the major known systems that are either live or have been made known through interactive demonstrations or pre-recorded demonstrations.

BeVocal (TM) is a web based information look-up service offering driving directions, flight information, weather and stock quotes. The service is provided by BeVocal of Santa Clara, Calif. USA, and may be accessed at www.bevocal.com. The system uses menu based interaction with menus requiring up to seven choices, which exceeds short-term memory capacity. The user enters a home location: BeVocal Home where the user is given a range of options and can then enter other services. Users must move between services via the home location although some jumping between selected services is permitted.

The system resolves errors by telling the user that they cannot be understood. Users are then either given a set of menu choices or the home location menu options, depending on where they are in the system. Different messages are played to the user on a multi-stage error resolution process until ultimately the user is logged off.

To use the system the user has to learn a set of commands including universal commands such as the names of services, pause, repeat etc. which can be used anywhere in the system; and specific service commands peculiar to each service. The system suffers from the disadvantage that while universal commands can be easily learnt, specific service commands are less intuitive and take longer to learn. Moreover, the user also has to learn a large set of menu based commands that are not always intuitive. The system also has a poor tolerance of out of context grammar; that is users using the “wrong” input text for a specific command or request. Furthermore, the ASR requires a slow and clear speaking rate which is undesirable as it is unnatural. The system also provides complicated navigation with the user being unable to return to the main menu and having to log off in some circumstances.

Nuance (TM) is a speech recognition toolkit provided by Nuance, Inc. of Menlo Park, Calif., USA and available at www.nuance.com. At present only available as a demonstration, it allows shopping, stock market questions, banking and travel services.

The same company also offers a spoken language interface with a wider range of functionality under the trademark NUANCE VOYAGER VOICE BROWSER, and which can access web based information such as news, sport, directions, travel etc.

The Nuance System uses a constrained query interaction style; prompts ask the user for information in a query style such as “where do you want to fly to?” but only menu like responses are recognised. Each service is accessed independently and user inputs are confirmed after several pieces of information have been input. This approach has the disadvantage of leading to longer error resolution times when an error occurs. Error resolution techniques vary from service to service with some prompting the input to be repeated before returning to a menu while others state that the system does not understand the input.

The system suffers from a number of further disadvantages: the TTS (Text To Speech) is difficult to understand and remember. TTS lists tend to be long, compounding their difficulty. The system does not tolerate fast speech rates and has poor acceptance of out of grammar problems; short preambles are tolerated but nothing else, with the user being restricted single word utterances. This gives the system an unnatural feel which is contrary to the principles of spoken language interfaces.

Philips Electronic Restaurant Guide is a dial-up guide to London (UK) restaurants. The user can specify the restaurant type, for example regional variety, location and price band and then be given details of restaurants meeting those criteria.

The interactions style is query level but requires the user to specify information in the correct order. The system has a single recursive structure so that at the end of the restaurant information the user can exit or start again. The system handles error resolution poorly. A user choice is confirmed after type, location and price information has been entered. The user is then asked to confirm the information. If it is not confirmed, the user is asked what is wrong with it but the system cannot recognise negative statements and interprets a negative statement such as “I don't want . . .” as an affirmative. As such, errors are not resolved.

The system offers a limited service and does not handle out of grammar tokens well. In that case, if a location or restaurant is out of grammar the system selects an alternative, adopting a best-fit approach but without informing the user.

CheckFreeEasy™ is the voice portal of Checkfree.com, an on-line bill paying service provided by Checkfree.com Inc of Norcross, Ga., USA and available at www.checkfree.com. The system is limited in that it supports a spoken numeric menu only and takes the user through a rigid structure with very few decision points. Confirmation of input occurs frequently, but error resolution is cumbersome with the user being required to listen to a long error message before re-entering information. If the error persists this can be frustrating although numerical data can be entered using DTMF input.

The system is very restricted and input of multi digit strings has to be handled slowly and carefully. There is no facility for handling out of grammar tokens.

Wildfire™ is a personal assistant voice portal offered by Wildfire Communications, Inc of Lexington, Mass., USA; and available at www.wildfire.com. The personal assistant manages phone, fax and e-mail communications, dials outgoing calls, announces callers, remembers important numbers and organises messages.

The system is menu based and allows lateral navigation. Available information is limited as the system has only been released as a demonstration.

Tellme™ of Tell Me Networks, Inc of Mountain View, Calif., USA is available at www.tellme.com. It allows users to access information and to connect to specific providers of services. Users can access flight information and then connect to a carrier to book a flight etc. The system provides information on restaurants, movies, taxis, airlines, stock quotes, sports, news, traffic, weather, horoscopes, soap operas, lottery, blackjack and phone booth; it then connects to providers of these services.

The interaction style is driven by a key word menu system and has a main menu from which all services branch. All movement though the system is directed through the main menu. Confirmation is given of certain aspects of user input but there is no immediate opportunity to correct the information. Errors are resolved by a series of different error messages which are given during the error resolution process, following which the available choices are given in a menu style.

The system suffers from the disadvantage that the TTS is stilted and unnatural. Moreover, the user must learn a set of navigation commands. There are a set of universal commands and also a set of service specific commands. The user can speak at a natural pace. However, the user is just saying single menu items. The system can handle short preamble such as mmm, erm, but not out of grammar phrases, or variants on in grammar phrases such as following the prompt: “Do you know the restaurant you want?” (Grammar Yes/No) Response: “I don't think so”. The navigation does not permit jumping between services. The user must always navigate between services via the main menu and can only do so when permitted to by the system.

Overall the system suffers form the disadvantage of having no system level adaptive learning, which makes the dialogue flow feel slow and sluggish once the user is familiar with the system.

Quack™ is a voice portal provided by Quack.com of Sunnyvale, Calif., USA at www.quack.com. It offers voice portal access to speech enables web-site information, such as: movie listings, restaurants, stocks, traffic, weather, sports and e-mail reading. The system is entirely menu driven and provides a runway, from which all services branch. From the runway users can “Go to . . .” any of the available services. Confirmation is given when users must input non-explicit menu items (e.g. in movies the user is asked for the name of a movie, as the user gives the title this is confirmed). No other confirmation is given. The error resolution cycle involves presentation of a series of “I'm sorry, but I didn't understand. . .” messages. This is followed by reminding the user of available menu items. The system suffers from the disadvantage of a poor TTS which can sound as if several different voices are contributing to each phrase.

Although this is a system directed dialogue some user-initiative is permitted and the user can personalise the interaction. User-initiative is facilitated by giving the user a set of navigation commands. For personalisation the user can call the system and register their local theatre, favourite sports team, or give their home location to enable the system to give personal information by default. The user must learn the permitted grammar in each service. However, there is little to learn because the menus are generally explicit. The system allows the use of short preambles (e.g. mmm, urh, etc), but it will not tolerate long preambles. In addition, it is extremely intolerant of anything out of grammar. For example, using “Go traffic” instead of “Go to traffic” results is an error prompt.

The user can use a range of navigation commands (e.g. help, interrupt, go back, repeat, that one, pause and stop).

Telsurf™ is a voice portal to web based information such as stocks, movies, sports, weather, etc and to a message centre, including a calender service, e-mail, and address book. The service is provided by Telsurf, Inc of Westlake Village, Calif., USA and available at www.888telsurf.com. The system is query/menu style using single words and has a TTS which sounds very stilted and robotic. The user is required to learn universal commands and service specific commands.

NetByTel of NetByTel Inc, of Boca Raton, Fla., USA is a service which offers voice access and interaction with e-commerce web sites. The system is menu based offering confirmation after a user input that specifies a choice.

Another disadvantage of known systems relates to the complexity of configuring, maintaining and modifying voice-responsive systems, such as SLIs. For example, voice activated input to application software generally requires a skilled computer programmer to tailor an application program interface (API) for each application that is to receive information originating from voice input. This is time consuming, complex and expensive, and limits the speed with which new applications can be integrated into a new or pre-existing voice-responsive system.

A further problem with known systems is how to define acceptable input phrases which a voice-responsive system can recognise and respond to. Until fairly recently, acceptable input phrases have had to be scripted according to a specific ASR application. These input phrases are fixed input responses that the ASR expects in a predefined order if they are to be accepted as valid input. Moreover, ASR specific scripting requires not only linguistic skill to define the phrases, but also knowledge of the programming syntax specific to each ASR application that is to be used. In order to address this latter issue, software applications have been developed that allow a user to create a grammar that can be used by more than one ASR. An example of such a software application is described in U.S. Pat. No. 5,995,918 (Unisys). The Unisys system uses a table-like interface to define a set of valid utterances and goes some way towards making the setting up of a voice-responsive system easier. However, the Unisys system merely avoids the need for the user to know any specific programming syntax.

In summary, none of the known systems that have been described disclose or suggest a spoken language mechanism, interface or system in which non- directed dialogue can, for example, be used to allow the user to change the thread of conversations held with a system exploiting a spoken language mechanism or interface. Additionally, setting up, maintaining and modifying voice-responsive systems is difficult and generally requires specialised linguistic and/or programming skills.

### SUMMARY OF INVENTION

We have appreciated that there is a need for an improved spoken language interface that removes or ameliorates the disadvantages of the existing systems mentioned above and the invention, in its various aspects, aims to provide such a system.

According to a first aspect of the invention, there is provided a spoken language interface for speech communications with an application running on a computer system, comprising: an automatic speech recognition system (ASR) for recognising speech inputs from a user; a speech generation system for providing speech to be delivered to the user; a database storing as data speech constructs which enable the system to carry out a conversation for use by the automatic speech recognition system and the speech generation system, the constructs including prompts and grammars stored in notation independent form; and a controller for controlling the automatic speech recognition system, the speech generation system and the database.

Embodiments of this aspect of the invention have the advantage that as speech grammars and prompts are stored as data in a database they are very easy to modify and update. This can be done without having to take the system down. Furthermore, it enables the system to evolve as it gets to know a user, with the stored speech data being modified to adapt to each user. New applications can also be easily added to the system without disturbing it.

According to a second aspect of the invention there is provided a spoken language interface for speech communications with an application running on a computer system, comprising: an automatic speech recognition system for recognising speech inputs from a user; a speech generation system for providing speech to be delivered to the user; an application manager for providing an interface to the application and comprising an internal representation of the application; and a controller for controlling the automatic speech recognition system, the text to speech and the application manager. This aspect of the invention has the advantage that new applications may easily be added to the system by adding a new application manager and without having to completely reconfigure the system. It has the advantage that it can be built by parties with expertise in the applications domain but with no expertise in SLIs. It has the advantage that it doesn't have to be redesigned when the flow of the business process it supports changes—this being handled by the aforementioned aspect of the invention in which workflow structures are stored in the database. It has the further advantage that updated or modified versions of each application manager can be added without affecting the other parts of the system or shutting them down including the old version of the respective application.

According to a further aspect of the invention there is provided a spoken language interface for speech communications with an application running on a computer system, comprising: an automatic speech recognition system for recognising speech inputs from a user; a speech generation system for providing speech to be delivered to the user; a session manager for controlling and monitoring user sessions, whereby on interruption of a session and subsequent re-connection a user is reconnected at the point in the conversation where the interruption took place; and a controller for controlling the session manager, the automatic speech generator and the text to speech system.

This aspect of the invention has the advantage that if a speech input is lost, for example if the input is via a mobile telephone and the connection is lost, the session manager can ensure that the user can pick up the conversation with the applications at the point at which it was lost. This avoids having to repeat all previous conversation. It also allows for users to intentionally suspend a session and to return to it at a later point in time. For example when boarding a flight and having to switch off a mobile phone.

A further aspect of the invention provides a method of handling dialogue with a user in a spoken language interface for speech communication with applications running on a computer system, the spoken language interface including an automatic speech recognition system and a speech generation system, the method comprising: listening to speech input from a user to detect a phrase indicating that the user wishes to access an application; on detection of the phrase, making the phrase current and playing an entry phrase to the user; waiting for parameter names with values to be returned by the automatic speech recognition system and representing user input speech; matching the user input parameter manes with all empty parameters in a parameter set associated with the detected phrase which do not have a value and populating empty parameters with appropriate values from the user input speech; checking whether all parameters in the set have a value and, if not, playing to the user a prompt to elicit a response for the next parameter without a value; and when all parameters in the set have a value, marking the phrase as complete.

According to an aspect of the invention there is provided a spoken language interface mechanism for enabling a user to provide spoken input to at least one computer implementable application, the spoken language interface mechanism comprising an automatic speech recognition (ASR) mechanism operable to recognise spoken input from a user and to provide information corresponding to a recognised spoken term to a control mechanism, said control mechanism being operable to determine whether said information is to be used as input to said at least one application, and conditional on said information being determined to be input for said at least one application, to provide said information to said at least one application. In a particular embodiment, the control mechanism is operable to provide said information to said at least one application when non-directed dialogue is provided as spoken input from the user.

According to this aspect of the invention, the spoken term may comprise any acoustic input, such as, for example, a spoken number, letter, word, phrase, utterance or sound. The information corresponding to a recognised spoken term may be in the form of computer recognisable information, such as, for example, a string, code, token or pointer that is recognisable to, for example, a software application or operating system as a data or control input. In various embodiments according to this aspect of the invention, the control mechanism comprises a voice controller and/or a dialogue manager.

The spoken language interface mechanism may comprise a speech generation mechanism for converting at least part of an output response or request from an application to speech. The speech generation mechanism may comprise one or more automatic speech generation system. The spoken language interface mechanism may comprise a session management mechanism operable to track a user's progress when performing one or more tasks, such as, for example, composing an e-mail message or dictating a letter or patent specification. The session management mechanism may comprise one or more session and notification manager. The spoken language interface mechanism may comprise an adaptive learning mechanism. The adaptive learning mechanism may comprise one or more personalisation and adaptive learning unit. The spoken language interface mechanism may comprise an application management mechanism. The application management mechanism may comprise one or more application manager.

Any of the mechanisms may be implemented by computer software, either as individual elements each corresponding to a single mechanism or as part of a bundle containing a plurality of such mechanisms. Such software may be supplied as a computer program product on a carrier medium, such as, for example, at least one of the following set of media: a radio-frequency signal, an optical signal, an electronic signal, a magnetic disc or tape, solid-state memory, an optical disc, a magneto-optical disc, a compact disc and a digital versatile disc.

According to another aspect of the invention, there is provided a spoken language system for enabling a user to provide spoken input to at least one application operating on at least one computer system, the spoken language system comprising an automatic speech recognition (ASR) mechanism operable to recognise spoken input from a user, and a control mechanism configured to provide to said at least one application spoken input recognised by the automatic speech recognition mechanism and determined by said control mechanism as being input for said at least one application operating on said at least one computer system. In particular, the control mechanism may be further operable to be responsive to non-directed dialogue provided as spoken input from the user.

The spoken language system according to this aspect of the invention may comprise a speech generation mechanism for converting at least part of any output from said at least one application to speech. This can, for example, permit the spoken language system to audibly prompt a user for a response. However, other types of prompt may be made available, such as, for example, visual and/or tactile prompts.

According to yet another aspect of the invention, there is provided a method of providing user input to at least one computer implemented application, comprising the steps of configuring an automatic speech recognition mechanism to receive spoken input, operating the automatic speech recognition mechanism to recognise spoken input, and providing to said at least one application spoken input determined as being input for said at least one application. In a particular embodiment the provision of the recognised spoken input to said at least one application is not conditional upon the spoken input following a directed dialogue path. The method of providing user input according to this aspect of the invention may further comprise the step of converting at least part of any output from the at least one application to speech.

Other methods according to aspects of the invention which correspond to the various mechanisms, systems, interfaces, development tools and computer programs may also be formulated, and these are all intended to fall within the scope of the invention.

Various aspects of the invention employ non-directed dialogue. By using non-directed dialogue the user can change the thread of conversations held with a system that uses a spoken language mechanism or interface. This allows the user to interact in a more natural manner akin to a natural conversation with, for example, applications that are to be controlled by the user. For example, a user may converse with one application (e.g. start composing an e-mail) and then check a diary appointment using another application before returning to the previous application to continue where he/she left off previously. Furthermore, employing non-directed or non-menu-driven dialogue allows a spoken language mechanism, interface or system according to various aspects of the invention to avoid being constrained during operation to a predetermined set of valid utterances. Additionally, the ease of setting up, maintaining and modifying both current and non-directed dialogue voice-responsive systems is improved by various aspects of the present invention as the requirements for specialised linguistic and/or programming skills is reduced.

According to another aspect of the invention there is provided a development tool for enabling a user to create components of a spoken language interface. This permits a system developer, or ordinary user, easily to create a new voice-responsive system, e.g. including a spoken language interface mechanism as herein described, or add further applications to such a system at a later date, and enables there to be a high degree of interconnectivity between individual applications and/or within different parts of one or more individual application. Such a feature provides for enhanced navigation between parts or nodes of an application or applications. Additionally, by permitting the reuse of workgroups between different applications, the rapid application development tool reduces the development time needed to produce a system comprising more than one voice-controlled application, such as for example a software application.

According to one aspect, there is provided a development tool for creating a spoken language interface mechanism for enabling a user to provide spoken input to at least one application, said development tool comprising an application design tool operable to create at least one dialogue defining how a user is to interact with the spoken language interface mechanism, said dialogue comprising one or more inter-linked nodes each representing an action, wherein at least one said node has one or more associated parameter that is dynamically modifiable, e.g. during run-time, while the user is interacting with the spoken language interface mechanism. By enabling parameters to be dynamically modifiable, for example, in dependence upon the historical state of the said one or more associated parameter and/or any other dynamically modifiable parameter, this aspect of the invention enables the design of a spoken language interface mechanism that can understand and may respond to non-directed dialogues.

The action represented by a node may include one or more of an input event, an output action, a wait state, a process and a system event. The nodes may be represented graphically, such as for example, by icons presented through a graphical user interface that can be linked, e.g. graphically, by a user. This allows the user to easily select the components required, to design, for example, a dialogue, a workflow etc., and to indicate the relationship between the nodes when designing components for a spoken language interface mechanism. Additionally, the development tool ameliorates the problem of bad workflow design (e.g. provision of link conditions that are not mutually exclusive, provision of more than one link without conditions, etc.) that are sometimes found with known systems.

The development tool comprises an application design tool that may provide one or more parameter associated with a node that has an initial default value or plurality of default values. This can be used to define default settings for components of the spoken language interface mechanism, such as, for example, commonly used workflows, and thereby speed user development of the spoken language interface mechanism. The development tool may comprise a grammar design tool that can help a user write grammars. Such a grammar design tool may be operable to provide a grammar in a format that is independent of the syntax used by at least one automatic speech recognition system so that the user is relieved of the task of writing scripts specific to any particular automatic speech recognition system. One benefit of the grammar design tool includes enabling a user, who may not necessarily have any particular computer expertise, to more rapidly develop grammars. Additionally, because a centralised repository of grammars may be used, any modifications or additions to the grammars needs only to be made in a single place in order that the changes/additions can permeate through the spoken language interface mechanism.

In one embodiment according to an aspect of the invention, there is provided a development suite comprising a development tool as herein described. The development suite may include dialogue flow construction, grammar creation and/or debugging and analysis tools. Such a development suite may be provided as a software package or tool that may be supplied as a computer program code supplied on a carrier medium. Other aspects and advantages of the invention will be apparent from the following description and the appended claims.

### BRIEF DESCRIPTION OF DRAWINGS

FIG. 1 is an architectural overview of a system embodying the invention.

FIG. 2 is an overview of the architecture of the system.

FIG. 3 is a detailed architectural view of the dialogue manager and associated components.

FIG. 4 is a view of a prior art delivery of dialogue scripts.

FIG. 5 illustrates synchronous communication using voice and other protocols.

FIG. 6 illustrates how resources can be managed from the voice controller.

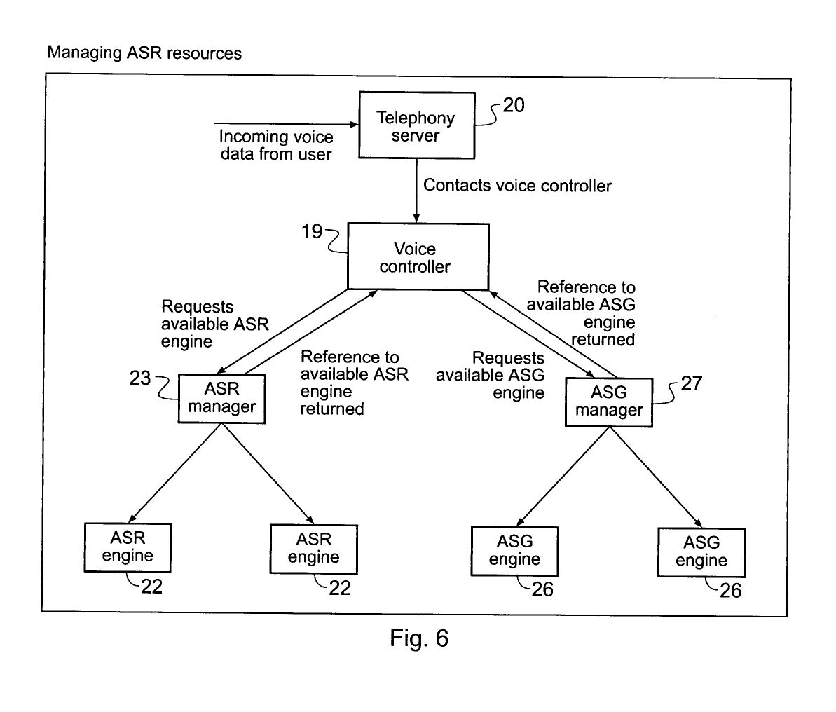

FIG. 7 illustrates the relationship between phrases, parameters, words and prompts.

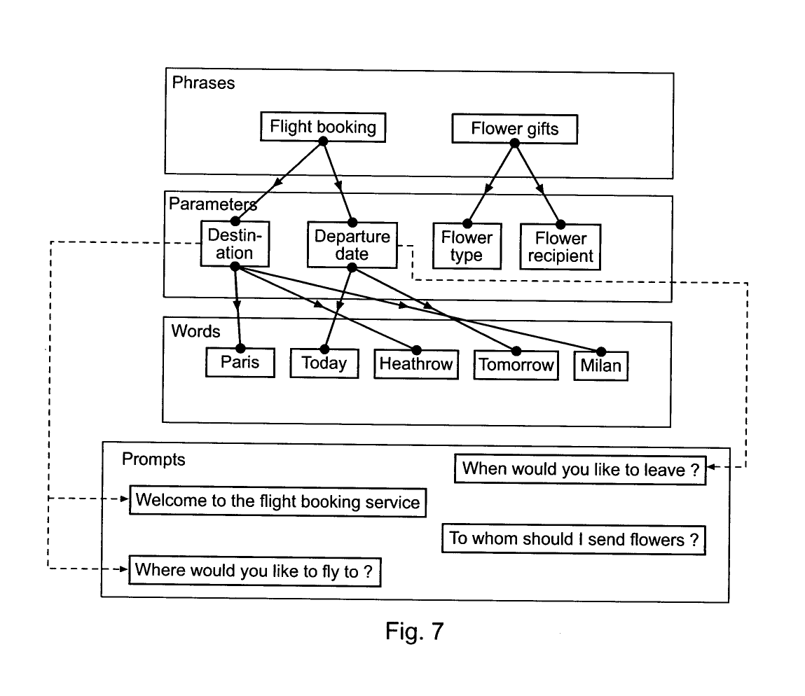

FIG. 8 illustrates the relationship between parameters and parameterSet classes.

FIG. 9 illustrates flowlink selection bases on dialogue choice.

FIG. 10 illustrates the stages in designing a dialogue for an application.

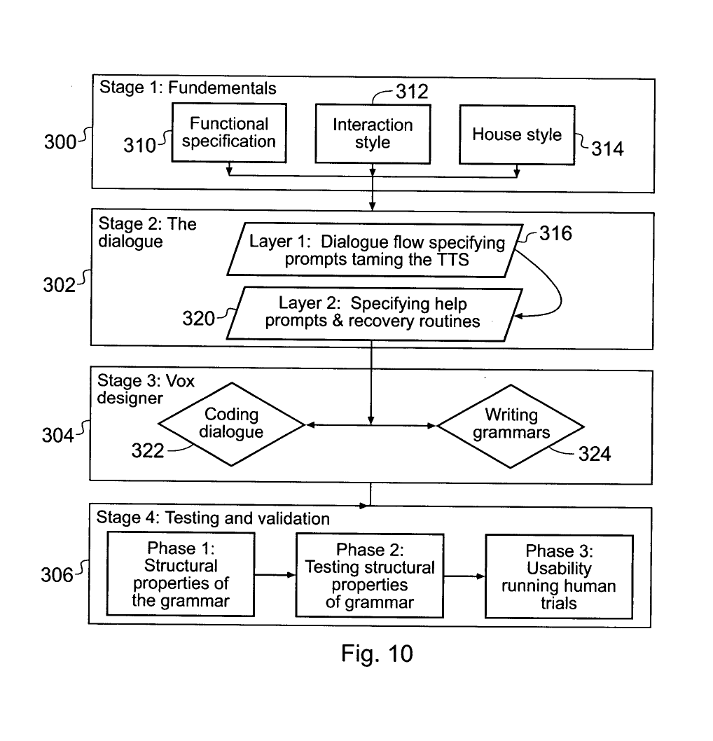

FIG. 11 shows the relationship between various SLI objects.

FIG. 12 shows the relationship between target and peripheral grammars.

FIG. 13 illustrates the session manager.

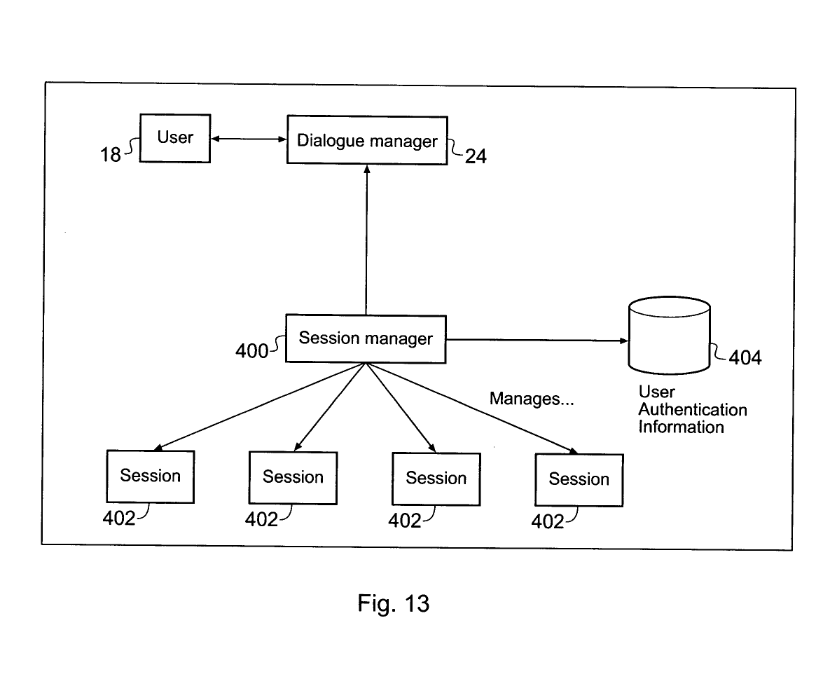

FIG. 14 illustrates how the session manager can reconnect a conversation after a line drop.

FIG. 15 illustrates the application manager.

FIG. 16 illustrates the personalisation agent.

### DETAILED DESCRIPTION

A preferred embodiment of the invention has the advantage of being able to support run time loading. This means that the system can operate all day every day and can switch in new applications and new versions of applications without shutting down the voice subsystem. Equally, new dialogue and workflow structures or new versions of the same can be loaded without shutting down the voice subsystem. Multiple versions of the same applications can be run. The system includes adaptive learning which enables it to learn how best to serve users on global (all users), single or collective (e.g. demographic groups) user basis. This tailoring can also be provided on a per application basis. The voice subsystem provides the hooks that feed data to the adaptive learning engine and permit the engine to change the interfaces behaviour for a given user.

The key to the run time loading, adapting learning and many other advantageous features is the ability to generate new grammars and prompts on the fly and in real time which are tailored to that user with the aim of improving accuracy, performance and quality of user interaction experience. This ability is not present in any of the prior art systems. A grammar is a defined set of utterances a user might say. It can be predefined or generated in real time; a dynamic grammar. Dialogue scripts used in the prior art are lists of responses and requests for responses. They are effectively a set of menus and do not give the user the opportunity to ask questions. The system of the present invention is conversational allowing the user to ask questions, check and change data and generally in a flexible conversational manner. The systems side of the conversation is built up in a dialogue manager.

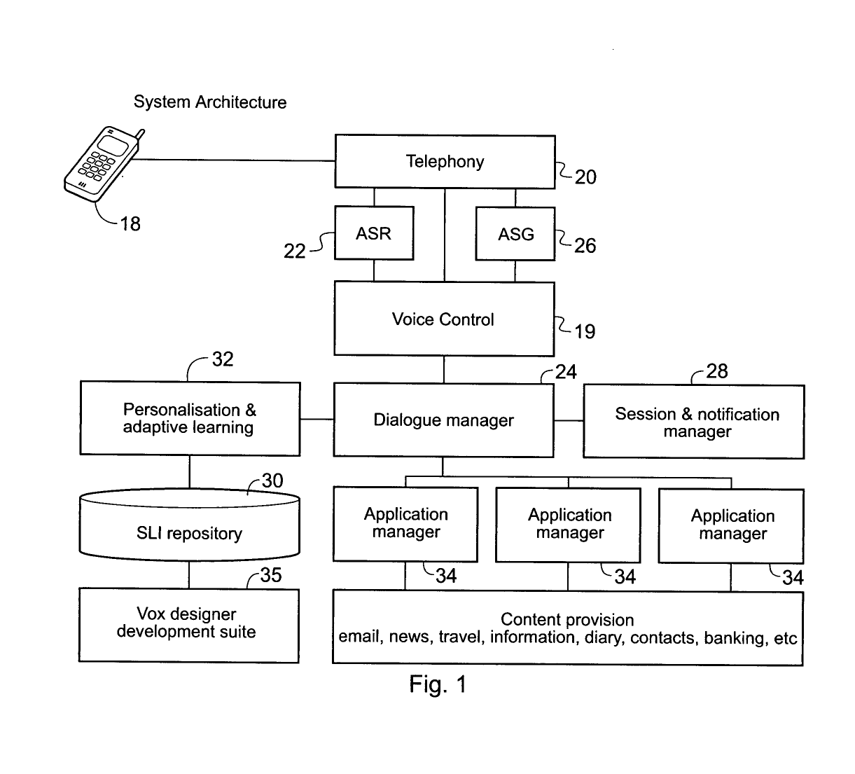

The system schematically outlined in FIG. 1 is intended for communication with applications via mobile, satellite, or landline telephone. However, it should be understood that the invention is not limited to such systems and is applicable to any system where a user interacts with a computer system, whether it is direct or via a remote link. For example, the principles of the invention could be applied to navigate around a PC desktop, using voice commands to interact with the computer to access files and applications, send e-mails and other activities. In the example shown this is via a mobile telephone 18 but any other voice telecommunications device such as a conventional telephone can be utilised. Calls to the system are handled by a telephony unit 20. Connected to the telephony unit are a Voice Controller 19, an Automatic Speech Recognition System (ASR) 22 and a automatic speech generation system 26. The ASR 22 and ASG systems are each connected to the voice controller 19. A dialogue manager 24 is connected to the voice controller 19 and also to a spoken language interface (SLI) repository 30, a personalisation and adaptive learning unit 32 which is also attached to the SLI repository 30, and a session and notification manager 28. The Dialogue Manager is also connected to a plurality of Application Managers AM, 34 each of which is connected to an application which may be content provision external to the system. In the example shown, the content layer includes e-mail, news, travel, information, diary, banking etc. The nature of the content provided is not important to the principles of the invention.

The SLI repository is also connected to a development suite 35 that was discussed previously.

The system to be described is task oriented rather than menu driven. A task oriented system is one which is conversational or language oriented and provides an intuitive style of interaction for the user modelling the user's own style of speaking rather than asking a series of questions requiring answers in a menu driven fashion. Menu based structures are frustrating for users in a mobile and/or aural environment. Limitations in human short-term memory mean that typically only four or five options can be remembered at one time. “Barge-In”, the ability to interrupt a menu prompt, goes some way to overcoming this but even so, waiting for long option lists and working through multi-level menu structures is tedious. The system to be described allows users to work in a natural a task focussed manner. Thus, if the task is to book a flight to JFK Airport, rather than proceeding through a series of menu options, the user simply says: “I want to book a flight to JFK.”. The system accomplishes all the associated sub tasks, such as booking the flight and making an entry in the users diary for example. Where the user has needs to specify additional information this is gathered in a conversational manner, which the user is able to direct.

The service to be described allows natural switching from one context to another. A context is a topic of conversation or a task such as e-mail or another application with an associated set of predicted language models. Embodiments of the SLI technology may incorporate a hybrid rule-based and stochastic language modelling technique for automatic recognition and machine generation of speech utterances. Natural switching between contexts allows the user to move temporarily from, for example, flight booking, to checking available bank funds, before returning to flight booking to confirm the reservation.

The system to be described can adapt to individual user requirements and habits. This can be at interface level, for example, by the continual refinement of dialogue structure to maximise accuracy and ease of use, and at the application level, for example, by remembering that a given user always sends flowers to their partner on a given date.

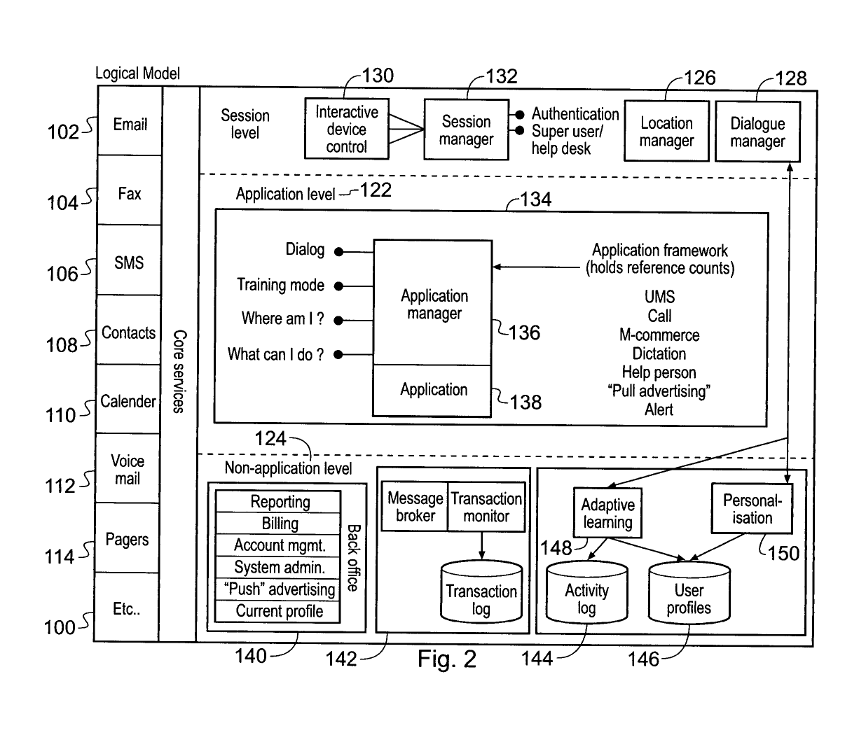

FIG. 2 provides a more detailed overview of the architecture of the system. The automatic speech generation unit 26 of FIG. 1 includes a basic TTS unit, a batch TTS unit 120, connected to a prompt cache 124 and an audio player 122. It will be appreciated that instead of using generated speech, pre-recorded speech may be played to the user under the control of the voice control 19. It the embodiment illustrated a mixture of pre-recorded voice and TTS is used.

The system then comprises three levels: session level 120, application level 122 and non-application level 124. The session level comprises a location manager 126 and a dialogue manager 128. The session level also includes an interactive device control 130 and a session manager 132 which includes the functions of user identification and Help Desk.

The application layer comprises the application framework 134 under which an application manager controls an application. Many application managers and applications will be provided, such as UMS (Unified Messaging Service), Call connect & conferencing, e-Commerce, Dictation etc. The non-application level 124 comprises a back office subsystem 140 which includes functions such as reporting, billing, account management, system administration, “push” advertising and current user profile. A transaction subsystem 142 includes a transaction log together with a transaction monitor and message broker.

In the final subsystem, an activity log 144 and a user profile repository 146 communicate with an adaptive learning unit 148. The adaptive learning unit also communicates with the dialogue manager 128. A personalisation module 150 also communicates with the user profiles repository 146 and the dialogue manager 128.

Referring back to FIG. 1, the various functional components are briefly described as follows:

Voice Control 19

This allows the system to be independent of the ASR 22 and TTS 26 by providing an interface to either proprietary or non-proprietary speech recognition, text to speech and telephony components. The TTS may be replaced by, or supplemented by, recorded voice. The voice control also provides for logging and assessing call quality. The voice control will optimise the performance of the ASR.

Spoken Language Interface Repository 30

In contrast to the prior art, grammars, that is constructs and user utterances for which the system listens, prompts and workflow descriptors are stored as data in a database rather than written in time consuming ASR/TTS specific scripts. As a result, multiple languages can be readily supported with greatly reduced development time, a multi-user development environment is facilitated and the database can be updated at anytime to reflect new or updated applications without taking the system down. The data is stored in a notation independent form. The data is converted or compiled between the repository and the voice control to the optimal notation for the ASR being used. This enables the system to be ASR independent.

ASR & ASG (Voice Engine) 22,26

The voice engine is effectively dumb as all control comes from the dialogue manager via the voice control.

Dialogue Manager 24

The dialogue manager controls the dialogue across multiple voice servers and other interactive servers (e.g. WAP, Web etc). As well as controlling dialogue flow it controls the steps required for a user to complete a task through mixed initiative—by permitting the user to change initiative with respect to specifying a data element (e.g. destination city for travel). The Dialog Manager may support comprehensive mixed initiative, allowing the user to change topic of conversation, across multiple applications while maintaining state representations where the user left off in the many domain specific conversations. Currently, as initiative is changed across two applications, state of conversation is maintained. Within the system, the dialogue manager controls the workflow. It is also able to dynamically weight the users language model by adaptively controlling the probabilities associated with the likely speaking style that the individual user employs dialogue structures in real-time, this is the chief responsibility the Adaptive Learning Engine and the current state of the conversation as a function of the current state of the conversation e user) with the user. The method by which the adaptive learning agent was conceived, is to collect user speaking data from call data records. This data, collected from a large domain of calls (thousands) provides the general profile of language usage across the population of speakers. This profile, or mean language model forms a basis for the first step in adjusting the language model probabilities to improve ASR accuracy. Within a conversation, the individual user's profile is generated and adaptively tuned across the user's subsequent calls. Early in the process, key linguistic cues are monitored, and based on individual user modelling, the elicitation of a particular language utterance dynamically invokes the modified language model profile tailored to the user, thereby adaptively tuning the user's language model profile and individual increasing the ASR accuracy for that user.

Finally, the dialog manager includes a personalisation engine. Given the user demographics (age, sex, dialect) a specific personality tuned to user characteristics for that user's demographic group is invoked.

The dialog manager also allows dialogue structures and applications to be updated or added without shutting the system down. It enables users to move easily between contexts, for example from flight booking to calendar etc, hang up and resume conversation at any point; specify information either step-by-step or in one complex sentence, cut-in and direct the conversation or pause the conversation temporarily.

Telephony

The telephony component includes the physical telephony interface and the software API that controls it. The physical interface controls inbound and outbound calls, handles conferencing, and other telephony related functionality.

Session and Notification Management 28

The Session Manager initiates and maintains user and application sessions. These are persistent in the event of a voluntary or involuntary disconnection. They can re-instate the call at the position it had reached in the system at any time within a given period, for example 24 hours. A major problem in achieving this level of session storage and retrieval relates to retrieving a session in which a conversation is stored with either a dialogue structure, workflow structure or an application manager has been upgraded. In the preferred embodiment this problem is overcome through versioning of dialogue structures, workflow structures and application managers. The system maintains a count of active sessions for each version and only retires old versions once the versions count reaches zero. An alternative, which may be implemented, requires new versions of dialogue structures, workflow structures and application managers to supply upgrade agents. These agents are invoked whenever by the session manager whenever it encounters old versions in the stored session. A log is kept by the system of the most recent version number. It may be beneficial to implement a combination of these solutions the former for dialogue structures and workflow structures and the latter for application managers.

The notification manager brings events to a user's attention, such as the movement of a share price by a predefined margin. This can be accomplished while the users are offline through interaction with the dialogue manager or offline. Offline notification is achieved either by the system calling the user and initiating an online session or through other media channels, for example, SMS, Pager, fax, email or other device.

Application Managers 34

Application Managers (AM) are components that provide the interface between the SLI and one or more of its content suppliers (i.e. other systems, services or applications). Each application manager (there is one for every content supplier) exposes a set of functions to the dialogue manager to allow business transactions to be realised (e.g. GetEmail( ), SendEmail( ), BookFlight( ), GetNewsltem( ), etc). Functions require the DM to pass the complete set of parameters required to complete the transaction. The AM returns the successful result or an error code to be handled in a predetermined fashion by the DM.

An AM is also responsible for handling some stateful information. For example, User A has been passed the first 5 unread emails. Additionally, it stores information relevant to a current user task. For example, flight booking details. It is able to facilitate user access to secure systems, such as banking, email or other. It can also deal with offline events, such as email arriving while a user is offline or notification from a flight reservation system that a booking has been confirmed. In these instances the AM's role is to pass the information to the Notification Manager.

An AM also exposes functions to other devices or channels, such as web, WAP, etc. This facilitates the multi channel conversation discussed earlier.

AMs are able to communicate with each other to facilitate aggregation of tasks. For example, booking a flight primarily would involve a flight booking AM, but this would directly utilise a Calendar AM in order to enter flight times into a users Calendar.

AMs are discrete components built, for example, as enterprise Java Beans (EJBs) they can be added or updated while the system is live.

Transaction & Message Broker 142 (FIG. 2:

The Transaction and Message Broker records every logical transaction, identifies revenue-generating transactions, routes messages and facilitates system recovery.

Adaptive Learning & Personalisation 32; 148, 150 (FIG. 2)

Spoken conversational language reflects quite a bit of a user's psychology, socio-economic background, and dialect and speech style. The reason an SLI is a challenge, which is met by embodiments of the invention, is due to these confounding factors. Embodiments of the invention provide a method of modelling these features and then tuning the system to effectively listen out for the most likely occurring features. Before discussing in detail the complexity of encoding this knowledge, it is noted that a very large vocabulary of phrases encompassing all dialectic and speech style (verbose, terse or declarative) results in a complex listening test for any recogniser. User profiling, in part, solves the problem of recognition accuracy by tuning the recogniser to listen out for only the likely occurring subset of utterance in a large domain of options.

The adaptive learning technique is a stochastic (statistical) process which first models which types, dialects and styles the entire user base of users employ. By monitoring the Spoken Language of many hundreds of calls, a profile is created by counting the language mostly utilised across the population and profiles less likely occurrences. Indeed, the less likely occurring utterances, or those that do not get used at all, could be deleted to improve accuracy. But then, a new user who might employ the deleted phrase, not yet observed, could come along and he would have a dissatisfying experience and a system tuned for the average user would not work well for him. A more powerful technique is to profile individual user preferences early on in the transaction, and simply amplify those sets of utterances over those utterances less likely to be employed. The general data of the masses is used initially to set a set of tuning parameters and during a new phone call, individual stylistic cues are monitored, such as phrase usage and the model is immediately adapted to suit that caller. It is true, those that use the least likely utterances across the mass, may initially be asked to repeat what they have said, after which the cue re-assigns the probabilities for the entire vocabulary.

The approach, then, embodies statistical modelling across an entire population of users. The stochastic nature of the approach occurs, when new observations are made across the average mass, and language modelling weights are adaptively assigned to tune the recogniser.

Help Assistant & Interactive Training

The Help Assistant & Interactive Training component allows users to receive real-time interactive assistance and training. The component provides for simultaneous, multi channel conversation (i.e. the user can talk through a voice interface and at the same time see visual representation of their interaction through another device, such as the web).

Databases

The system uses a commercially available database such as Oracle 8I from Oracle Corp.

Central Directory

The Central Directory stores information on users, available applications, available devices, locations of servers and other directory type information.

System Administration—Infrastructure

The System Administration—Applications, provides centralised, web-based functionality to administer the custom build components of the system (e.g. Application Managers, Content Negotiators, etc.

Development Suite (35)

This provides an environment for building spoken language systems incorporating dialogue and prompt design, workflow and business process design, version control and system testing. It is also used to manage deployment of system updates and versioning.

Rather than having to laboriously code likely occurring user responses in a cumbersome grammar (e.g. BNF grammar—Bachus Nauer Format) resulting in time consuming detailed syntactic specification, the development suite provides an intuitive hierarchical, graphical display of language, reducing the modelling act to creatively uncover the precise utterance but the coding act to a simple entry of a data string. The development suite enables a Rapid Application Development (RAD) tool that combines language modelling with business process design (workflow).

### Dialogue Subsystem

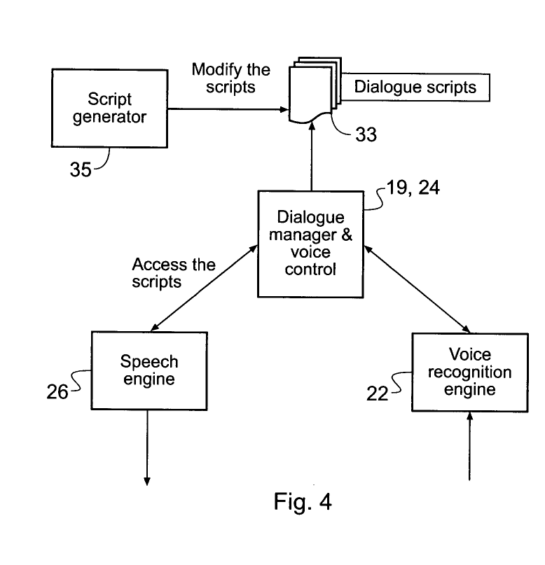

The Dialogue Subsystem manages, controls and provides the interface for human dialogue via speech and sound. Referring to FIG. 1, it includes the dialogue manager, spoken language interface repository, session and notification managers, the voice controller 19, the Automatic Speech Recognition Unit 22, the Automatic Speech Generation unit 26 and telephony components 20. The subsystem is illustrated in FIG. 4.

Before describing the dialogue subsystem in more detail, it is appropriate first to discuss what is a Spoken Language Interface (SLI).

A SLI refers to the hardware, software and data components that allow users to interact with a computer through spoken language. The term “interface” is particularly apt in the context of voice interaction, since the SLI acts as a conversational mediator, allowing information to be exchanged between user and system via speech. In its idealised form, this interface would be “invisible” and the interaction would, from the user's standpoint, appear as seamless and natural as a conversation with another person. In fact, one principle aim of most SLI projects is to create a system that is as near as possible to a human-human conversation.

If the exchange between user and machine is construed as a dialogue, the objective for the SLI development team is to create the ears, mind and voice of the machine. In computational terms, the ears of the system are created by the Automatic Speech Recognition (ASR) System 22. The voice is created via the Automatic Speech Generation (ASG) software 26, and the mind is made up of the computational power of the hardware and the databases of information contained in the system. The present system uses software developed by other companies for its ASR and ASG. Suitable systems are available from Nuance and Lemout & Hauspie respectively. These systems will not be described further. However, it should be noted that the system allows great flexibility in the selection of these components from different vendors. Additionally, the basic Text To Speech unit supplied, for example, by Lemout & Hauspie may be supplemented by an audio subsystem which facilitates batch recording of TTS (to reduce system latency and CPU requirements), streaming of audio data from other source (e.g. music, audio news, etc) and playing of audio output from standard digital audio file formats.

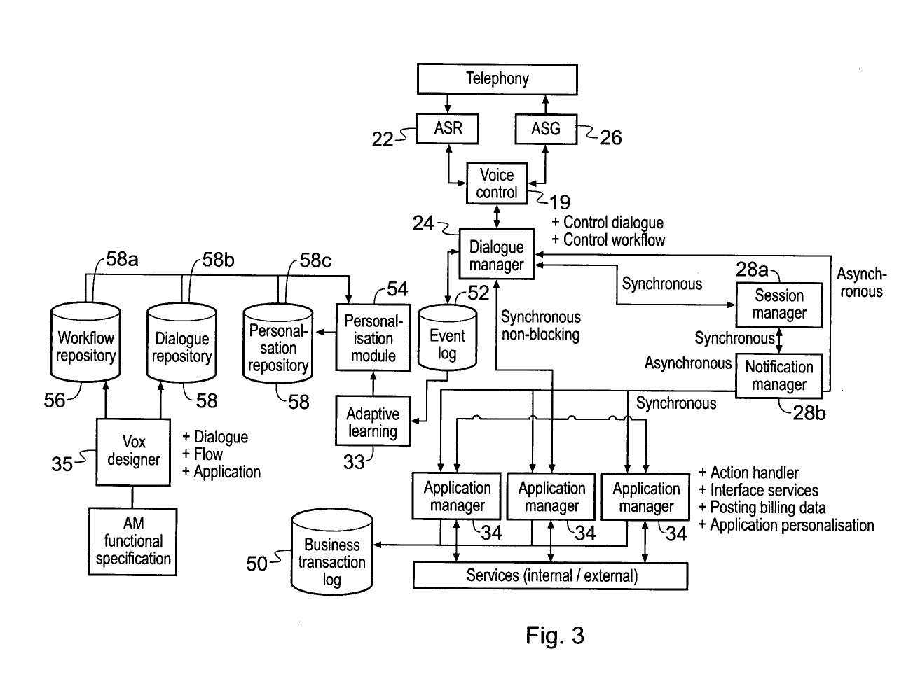

One implementation of the system is given in FIG. 3. It should be noted that this is a simplified description. A voice controller 19 and the dialogue manager 24 control and manage the dialogue between the system and the end user. The dialogue is dynamically generated at run time from a SLI repository which is managed by a separate component, the development suite.

The ASR unit 22 comprises a plurality of ASR servers. The ASG unit 26 comprises a plurality of speech servers. Both are managed and controlled by the voice controller.

The telephony unit 20 comprises a number of telephony board servers and communicates with the voice controller, the ASR servers and the ASG servers.

Calls from users, shown as mobile phone 18 are handled initially by the telephony server 20 which makes contact with a free voice controller. The voice controller contacts the locates an available ASR resource. The voice controller 19 which identifies the relevant ASR and ASG ports to the telephony server The telephony server can now stream voice data from the user to the ASR server and the ASG stream audio to the telephony server.

The voice controller, having established contacts with the ASR and ASG servers now requests a informs the Dialogue Manager which requests a session on behalf of a user in the session manager. As a security precaution, the user is required to provide authentication information before this step can take place. This request is made to the session manager 28 which is represented logically at 132 in the session layer in FIG. 2. The session manager server 28 checks with a dropped session store (not shown) whether the user has a recently dropped session. A dropped session could be caused by, for example, a user on a mobile entering a tunnel. This facility enables the user to be reconnected to a session without having to start over again.

The dialogue manager 24 communicates with the application managers 34 which in turn communicate with the internal/external services or applications to which the user has access. The application managers each communicate with a business transaction log 50, which records transactions and with the notification manager 28b. Communications from the application manager to the notification manager are asynchronous and communications from the notification manager to the application managers are synchronous. The notification manager also sends communications asynchronously to the dialogue manager 24. The dialogue manager 24 has a synchronous link with the session manager 28a, which has a synchronous link with the notification manager.

The dialogue manager 24 communicates with the adaptive learning unit 33 via an event log 52 which records user activity so that the system can learn from the users interaction. This log also provides a series of debugging and reporting information. The adaptive learning unit is connected to the personalisation module 34 which is in turn connected to the dialogue manager. Workflow 56, Dialogue 58 and Personalisation repositories 60 are also connected to the dialogue manager 24 through the personalisation module 554 so that a personalised view is always handled by the dialogue manager 24. These three repositories make up the SLI Repository referred to early.

As well as receiving data from the workflow, dialogue and personalisation repositories, the personalisation can also write to the personalisation repository 60. The Development Suite 35 is connected to the workflow and dialogue repositories 56, 58 and implements functional specifications of applications storing the relevant grammars, dialogues, workflow and application manager function references for each the application in the repositories. It also facilitates the design and implementation of system, help, navigation and misrecognition grammars, dialogues, workflow and action references in the same repositories.

The dialogue manager 24 provides the following key areas of functionality: the dynamic management of task oriented conversation and dialogue; the management of synchronous conversations across multiple formats; and the management of resources within the dialogue subsystem. Each of these will now be considered in turn.

Dynamic Management of Task Oriented Conversation and Dialogue

The conversation a user has with a system is determined by a set of dialogue and workflow structures, typically one set for each application. The structures store the speech to which the user listens, the keywords for which the ASR listens and the steps required to complete a task (workflow). By analysing what the users say, which is returned by the ASR, and combining this with what the DM knows about the current context of the conversation, based on current state of dialogue structure, workflow structure, and application & system notifications, the DM determines its next contribution to the conversation or action to be carried out by the AMs. The system allows the user to move between applications or context using either hotword or natural language navigation. The complex issues relating to managing state as the user moves from one application to the next or even between multiple instances of the same application is handled by the DM. This state management allows users to leave an application and return to it at the same point as when they left. This functionality is extended by another component, the session manager, to allow users to leave the system entirely and return to the same point in an application when they log back in—this is discussed more fully later under Session Manager.

The dialogue manager communicates via the voice controller with both the speech engine (ASG) 26 and the voice recognition engine (ASR) 22. The output from the speech generator 26 is voice data from the dialogue structures, which is played back to the user either as dynamic text to speech, as a pre-recorded voice or other stored audio format. The ASR listens for keywords or phrases that the user might say.

Typically, the dialogue structures are predetermined (but stochastic language models could be employed in an implementation of the system or hybrids of the two). Predetermined dialogue structures or grammars are statically generated when the system is inactive. This is acceptable in prior art systems as scripts tended to be simple and did not change often once a system was activated. However, in the present system, the dialogue structures can be complex and may be modified frequently when the system is activated. To cope with this, the dialogue structure is stored as data in a run time repository, together with the mappings between recognised conversation points and application functionality. The repository is dynamically accessed and modified by multiple sources even when active users are on-line.

The dialogue subsystem comprises a plurality of voice controllers 19 and dialogue managers 24 (shown as a single server in FIG. 3).

The ability to update the dialogue and workflow structures dynamically greatly increases the flexibility of the system. In particular, it allows updates of the voice interface and applications without taking the system down; and provides for adaptive learning functionality which enriches the voice experience to the user as the system becomes more responsive and friendly to a user's particular syntax and phraseology with time. Considering each of these two aspects in more detail:

Updates

Today we are accustomed to having access to services 24 hours a day and for mobile professionals this is even more the case given the difference in time zones. This means the system must run none stop 24 hours a day, 7 days a week. Therefore an architecture and system that allows new applications and services or merely improvements in interface design to be added with no affect on the serviceability of the system has a competitive advantage in the market place.

Adaptive Learning Functionality

Spoken conversational language reflects quite a bit of a user's psychology, socioeconomic background, dialect and speech style. One reason an SLI is a challenge is due to these confounding factors. The solution this system provides to this challenge is a method of modelling these features and then tuning the system to effectively listen out for the most likely occurring features—Adaptive Learning. Without discussing in detail the complexity of encoding this knowledge, suffice it to say that a very large vocabulary of phrases encompassing all dialectic and speech style (verbose, terse or declarative) results in a complex listening test for any ASR. User profiling, in part, solves the problem of recognition accuracy by tuning the recogniser to listen out for only the likely occurring subset of utterance in a large domain of options.

The adaptive learning technique is a stochastic process which first models which types, dialects and styles the entire user base of users employ. By monitoring the Spoken Language of many hundreds of calls, a profile is created by counting the language mostly utilised across the population and profiles less likely occurrences. Indeed, the less likely occurring utterances, or those that do not get used at all, can be deleted to improve accuracy. But then, a new user who might employ the deleted phrase, not yet observed, could come along and he would have a dissatisfying experience and a system tuned for the average user would not work well for him. A more powerful technique is to profile individual user preferences early on in the transaction, and simply amplify those sets of utterances over those utterances less likely to be employed. The general data of the masses is used to initially set a set of tuning parameters and during a new phone call, individual stylistic cues are monitored, such as phrase usage and the model is immediately adapted to suit that caller. It is true, those that use the least likely utterances across the mass, may initially be asked to repeat what they have said, after which the cue re-assigns the probabilities for the entire vocabulary.

### Managing Synchronous Conversations Across Multiple Formats

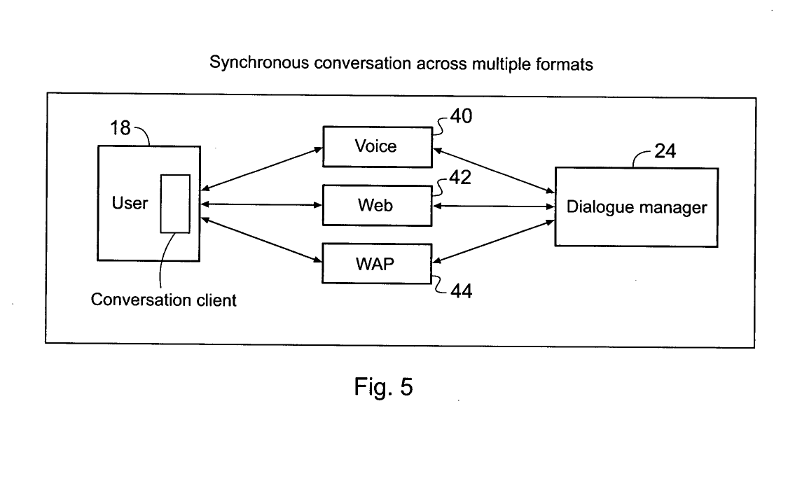

The primary interface to the system is voice. However, support is required for other distribution formats including web, WAP, e-mail and others. The system allows a conversation to be conducted synchronously across two or more formats. FIG. 5 illustrates the scenario with the synchronous conversation between the user 18 and the dialogue manager 24 being across one or more of voice 40, web 42, and WAP 44. To enable this functionality to work in the case of the Web 42, a downloadable web browser plugin, or other technology is required on the client side. Additionally, to allow it to work on WAP 42 it is reliant on the user initiating ‘pull’ calls from the WAP device to trigger downloads. However future iterations of the Wireless Application Protocol will allow information to be pushed to the WAP device. The important thing here is that the system supports these multi-channel conversations. The device or channel type is not important or restricted to current art.

The ability to support multiple format synchronous conversation is useful in providing training for new users, an interface for help desk operators and for supplying information not best suited to aural format. Considering these in turn:

Providing a Training Mode for New Users

New users to the system may initially experience a little difficulty adjusting to an interface metaphor where they are controlling and using a software system entirely via voice. A training mode is offered to users where they conduct a session via voice and at the same time view real-time feedback of their actions on their web browser or WAP screen. Having a visual representation of an interactive voice session, where the user can see their workflow, where they are in the system and how to navigate around, is a highly effective way to bring them up to speed with using the system.

Providing an Interface for Help Desk Operators

An important part of the service provided using the system is the ability to contact a human operator during a session if help is needed. When a user has successfully contacted a help desk operator, the operator takes advantage of the synchronous conversation functionality and “piggybacks” onto the user's current session. That is, the operator uses a desktop application to see, and control if necessary, the voice session that a user is having with the system. For example, a user in the middle of a session but is having trouble, say they are in the Calendar application and would like to compose an email in the email application but cannot remember the correct keywords to use. They say “Help” (for example) and are automatically patched through a help desk operator. They explain their problem to the operator who can see onscreen from the desktop application various items of information: who the user is; what tasks they are currently running; what stage they are in with those tasks, etc. The operator can then either notify the user of the corrective action, or they can directly move the user into the “Compose Email” task from their desktop application. After the operator returns the user to the voice session they will now be in the correct part of the system.

Formats Not Suitable for Voice

While voice provides an excellent means for human-computer interaction, it is not the solution for all requirements. Consider a user needing to access an address in a mobile environment, they will either need to remember the address or write it down if it's just spoken to them. This may in a number of situations be adequate, but in a great many it won't be. Using a visual channel such as SMS adds additional value to the voice proposition and neatly solves this problem by sending a text version of the address to the users mobile phone while they are hearing the aural one.

Managing Resources Within the Dialogue Subsystem

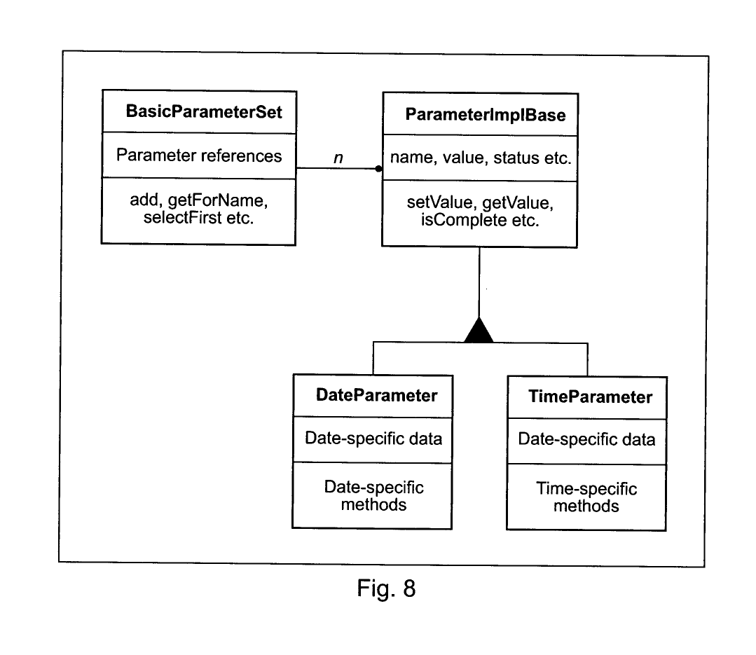

A key requirement of the system is to be able to cope with the predicted, or a greater, number of users using the system concurrently. The main bottleneck occurs at the dialogue subsystem as the ASR and ASG components are resource intensive in terms of CPU time and RAM requirements. FIG. 8 shows how resources may be effectively managed from the voice controller. This is through the use of the ASR Manager 23, and ASG Manager 27. Rather than communicating directly with the ASR and TTS servers, the voice controller communicates with the ASR Manager and TTS Manager which, in turn, evaluate the available resources and match up available resources to requests coming from the Dialogue Manager to maximize those resources.

Thus, when a user starts a voice session with the system the telephony server 20, which receives the voice data initially, contacts a voice controller 19 to find a free ASR resource from the dialogue subsystem to support the session. The DM in turn contacts the ASR Manager which checks its resource pool for an available resource. The resource pool is only a logical entity—the underlying resources may be physically distributed across a number of different services. A similar procedure is performed for the ASG engines using in ASG manager.

### Spoken Language Interface Structures Functionality

The core components and structure of the SLI will now be described. These components can be manipulated using the Designer tool, which will be described in due course.

1 Workflow and Conditions

A workflow encapsulates all dialogue pertaining to a specific application, and the logic for providing ‘dialogue flow’. It is made up of ‘flow components’ of phrases and actions described below, and a set of conditions for making transitions between these components based on the current context. These conditions have the effect of making decisions based on what the user has said, or on the response received from an application. The result of the condition is a flow component for the dialogue to move to. A condition can reference any ‘workflow variables’ or parameters. This is the mechanism by which the system remembers details provided by a user, and can make intelligent decisions at various points in the dialogue based on what has been said. The workflow is thus the ‘scope’ of the system's memory.

A workflow itself can also be a workflow component, such that a condition can specify another workflow as its target. A workflow controller manages the transitions between workflow components.

2 Phrases

A phrase is an SLI component used to encapsulate a set of related prompts and responses, usually oriented towards either performing a system action such as ordering some flowers or making a navigational choice in a dialogue, for example selecting a service. Each phrase has a corresponding grammar covering everything the user could be expected to say in specifying the action or in making the navigational choice. The objective of a phrase is to elicit sufficient data from a user to either perform a system action such as ordering some flowers, or to make a navigational choice in the dialogue such as selecting a service; the phrase encapsulates all the necessary components to do this: prompts, storage of specifications, corresponding grammar, reference to an action if appropriate.

A complete dialogue for an application will usually be constituted of many inter-related phrases.

3 Parameters

A parameter represents a discrete piece of information to be elicited from a user. In the flower booking example, information such as ‘flower type’, ‘flower quantity’ and ‘recipient’ are examples of parameters: information required by the system but not known when the dialogue starts. Parameters are linked to prompts, which specify the utterances that may be used to elicit the data, and to ‘words’, which represent the possible values (responses) for this parameter. A parameter can be either ‘empty’ or ‘filled’ depending on whether or not a value has been assigned for that parameter in the current dialogue. Parameters may be pre-populated from user preferences if appropriate.

4 Actions

An action is a flow component representing an invocation of a ‘system action’ in the system. When an action component is reached in a dialogue flow an action will be performed, using the current ‘context’ as input. Actions are independent of any workflow component. The majority of actions will also specify values for workflow parameters as their output; through this mechanism the dialogue can continue based on the results of processing.

5 Prompts

In order to maintain a dialogue, the dialogue manager has recourse to a set of prompts. Prompts may be associated with parameters, and with phrases. There is a wide range of prompts available ranging from data elicitation, for example: “What type of flowers would you like to order?”/“Who are the roses for?”) to completion notifications: for example “Your flower order has been placed, thank you for your custom”.

6 Words

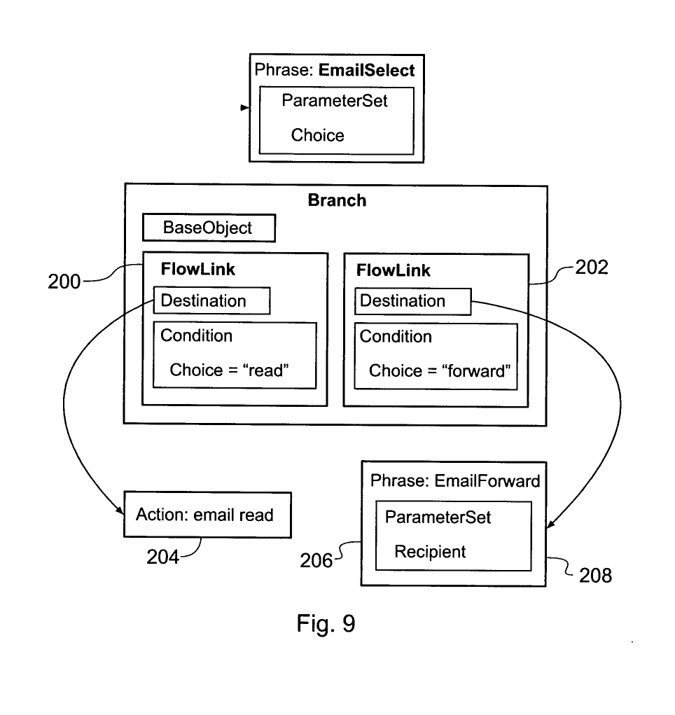

Words are specified as possible values for parameters. In a ‘flower booking’ scenario, the words corresponding to the ‘flowerType’ parameter may be roses, lilies, carnations. It is important that the system knows the possible responses, particularly as it may at times have to perform actions specific to what the user has said. The relationship between phrases, parameters, words and prompts is illustrated in FIG. 9.

### Core Dialogue Flow and Logic

A key feature of the system is that new dialogues are encoded as data only, without requiring changes to the ‘logic’ of the system. This data is stored in notation independent form. The dialogue manager is sufficiently generic that adding a new application necessitates changes only to the data stored in the database, as opposed to the logical operation of the dialogue manager.

The ‘default’ logic of the system for eliciting data, sending an action and maintaining dialogue flow is illustrated in the following description of system behaviour which starts from the point at which the system has established that the user wants to book some flowers:

The system makes the ‘flowerBooking’ phrase current, which is defined as the initial component in the current workflow. The ‘entry prompt’ associated with this phrase is played (“Welcome to the flower booking service”).

System waits for a response from the user. This will be returned by the ASR as a set of parameter names with values, as specified in the currently active grammar.

The system matches any parameters from the utterance against all parameters in the parameter Set of the current phrase that do not currently have a value. Matching empty parameters are populated with the appropriate values from the utterance.

The system checks whether all parameters in the current phrase have a value. If they have not, then the system identifies the next parameter without a value in the phrase; it plays the corresponding prompt to elicit a response from the user, and then waits for a response from the user as above. If sequences are specified for the parameters, this is accounted for when choosing the next parameter.

If all the parameters in the current phrase have been populated the system prompts the user to confirm the details it has elicited, if this has been marked as required. The phrase is then marked as ‘complete’.

Control now passes to the Workflow Controller, which establishes where to move the dialogue based on pre-specified conditions. For example, if it is required to perform an action after the phrase has completed then a link between the phrase and the action must be encoded in the workflow.

This default logic enables mixed initiative dialogue, where all the information offered by the user is accounted for, and the dialogue continues based on the information still required.

### Navigation and Context Switching

Task Orientation

‘Task orientation’, as mentioned earlier, is the ability to switch easily between different applications in the system, with applications being aware of the ‘context’ in which they were called, such that a user can perform their tasks quickly and efficiently. For example, a user's “task” maybe to arrange a business trip to France. This single task may involve booking a flight, booking a hotel, making entries in a diary and notifying the appropriate parties. Although this task involves different applications, the user can achieve this task quickly for three reasons:

1: The SLI can maintain state between applications so the user can leave one application, jump into another, before returning to the original application and continuing the dialogue where it was left;

2: The SLI can use information elicited in one application in another application. For example a user may book a flight, then go to the diary application and have the details automatically entered in the calendar; and

3: The SLI can, based on knowledge of the user and of business transactions, anticipate what the user wants to do next and offer to do this.

Navigation

The Utopian voice interface would allow the user to specify what he wants to do at any stage in the dialogue, and for the system to move to the appropriate task and account for everything the user has said. Were this possible, a user could be in the middle of a flight booking, realise they had to cancel a conflicting arrangement, tell the system to “bring up my diary for next Friday and cancel 11:00 appointment”, before returning to complete the flight booking transaction.

Current ASR technology currently precludes this level of functionality from being implemented in the system; if the system is ‘listening’ for all of the grammars in the system, recognition accuracy is unacceptable compromised. This necessitates a compromise that retains the essence of the approach. The user must explicitly navigate to the appropriate part of the system before providing details specific to their task. Usually this simply means stating “Vox <<application name>>”. Once the appropriate ASR technology is available it can be easily adopted into the system due to the systems ASR independent nature.

Applications are grouped in a shallow hierarchy under logical headings for ease of navigation. In one embodiment of the invention it is not be necessary to navigate more than 2 ‘levels’ to locate the required application. An example grouping is shown below:

Top Level
Flight Booking
Messages
   Send Email
Calendar
   Get Appointment

The SLI is always listening for context switches to any of the ‘top level’ phrases; in this case Flight Booking, Messages or Calendar), or to the immediate ‘parent’. Thus the only direct context switch not possible in the above scenario is from ‘Get Appointment’ to ‘Send Email’. Revisiting the example cited earlier, the business traveller could switch to his diary as follows:
System: “Welcome to Vox” (navigation state)
User: “Vox FlightBooking”
System: “Welcome to flight booking” (phrase state)
User: “I'd like to fly from Paris to Heathrow tomorrow”
System: “What time would you like to leave Heathrow?”
User: “Vox Calendar”
System: “Welcome to calendar”
User: “Bring up my diary for next Friday and cancel 11 am appointment”
System: “Your 11 o'clock appointment has been cancelled”
User: “Vox Flight Booking”
System: “Welcome back to Flight Booking. What time would you like to leave Heathrow?”

### Prompts in the SLI

All prompts are stored in a database, enabling the conversation manager to say “I am in this state and need to interact with the user in this style, give me the appropriate prompt”. This affords the system flexibility and makes it straightforward to change the dialogue text, should these be required. Furthermore it facilitates handling multiple languages, should this be required in the future. Prompts may be associated with phrases, with parameters, or be ‘stand-alone’ generic system prompts.

Prompt Types

Prompts are categorised to reflect all the different states the system may be in when it needs to interact with the user. Table 1 below shows some examples of the prompt types.

TABLE 1
Prompt Types

| Prompt Type | Description | Example |
|---|---|---|
| ELICITDATATYPE | This prompt is used | What type of |
| | when the system needs | flowers would you |
| | to ask the user to | like to order? |
| | provide a value for a | |
| | parameter. | |
| PARAMETERREAFFIRM | This prompt is used | I understood you |
| | when the system is not | want to fly on |
| | totally confident it has | September 20^{th}. |
| | understood an | |
| | utterance, but is not | |
| | sufficiently unsure to | |
| | explicitly ask for a | |
| | confirmation. | |
| LIST | | |
| ENTRY | This prompt is played | Welcome to Flight |
| | on first entering a | Booking. |
| | phrase. | |
| EXIT | This prompt is played | Thank you for |
| | on leaving a phrase. | using Flight |
| | | Booking. |
| AMBIGUITY | | |
| HELP | This prompt is used to | In flight booking |
| | provide help for a | you can state |
| | phrase, or for a | where you want to |
| | parameter. | fly to, and when |
| | | you want to fly, |
| | | and when you |
| | | want to return. |
| ACTIONCOMPLETE | This prompt is used to | Are you sure you |
| | confirm the details of | want to cancel the |
| | the dialogue before the | appointment? |
| | corresponding action is | |
| | committed. | |
| ACTIVEPHRASE- | This prompt is used to | Send an email |
| REMINDER | refer to a specific | |
| | phrase, to be used for | |
| | example if a user asks | |
| | to exit system with | |
| | remaining active | |
| | phrases. | |

Prompt Styles

A key feature of the interface is that it adapts according to the user's expertise and preferences, providing ‘dynamic dialogue’. This is achieved by associating a style with a prompt, so there can be different versions of the prompt types described above. The style categories may be as follows:

Prompt Verbosity: This can be specified as either ‘verbose’ or ‘terse’. Verbose prompts will be used by default for new users to the system, or those who prefer this type of interaction. Verbose prompts take longer to articulate. Terse prompts are SLItable for those who have gained a level of familiarity with the system.

Confirmation Style: In confirming details with the user, the system may choose an implicit or explicit style. Implicit prompts present information to the user, but to not ask for a response. This contrasts with explicit prompts, which both present information and request a response as to whether the information is correct.

Example Prompts:
Verbose: “Where would you like to fly from on Tuesday?”
Terse: “Destination airport?”
Explicit: “You would like to fly to Milan. Is this correct?”
Implicit: “You'd like to fly from Milan.”
   “When would you like to fly?” (Next prompt).
      Dynamic Prompts

In some cases prompts need to refer to information provided by the user that cannot be anticipated. The SLI therefore provides dynamic prompts, where a prompt can refer to parameter names which are substituted with the value of the parameter when the prompt is played. Below is an example of an ‘action confirm’ prompt for a Flight Booking dialogue; the parameter names are identified with a preceding ‘$’ symbol and are resolved before the prompt is played.

So, you want to fly from $fromDest to $toDest on the $fromdate returning $returnFlightFromDate . Do you want to book this flight?

In addition prompts may contain conditional clauses, where certain parts of the prompt are only played if conditions are met based on what the user has previously said. The following prompt would play “you have asked to order 1 item. Is this correct?” if the value of parameter NUMITEMS is 1, and “you have asked to order 3 items. Is this correct?” if the value of NUMITEMS is 3: you have asked to order $NUMITEMS !switch NUMITEMS 1|item not(1)|items !end. Is this correct?

Help and Recovery in the SLI

No matter how robust the system, or well designed the grammars, recognition errors are inevitable; it is necessary for the SLI to provide an appropriate level of help to the user. This section describes the use of help prompts in the system, and defines the behaviour of the system with respect to these prompts. There is a distinction between ‘help’ and ‘recovery’; help refers to the system behaviour when the user explicitly requests ‘help’, whereas recovery refers to system behaviour when the system has identified the user is having problems, for example low recognition confidence) and acts accordingly.

Help

The Help system is comprised of four Help domains:

1. Prompt Help (PH): A set verbose prompts, each associated with a normal dialogue prompt. These help prompts generally repeat and expand on the normal dialogue prompt to clarify what is required at that stage of the dialogue.

2. Application Help (AH): Provides a brief summary of the application the user is currently in, and the option of hearing a canned demonstration of how to work with the application.

3. Command Help (CH): This is a summary of the Hotwords and Command vocabulary used in the system.

4. Main System Help (SH): This is the main ‘top level’ Help domain, which gives a brief summary of the system, the applications, and the option to go to PH, AH, and CH domains for further assistance.

The user can access ALH, CLH, and SLH by saying the hotword ‘Vox Help’ at any time during their interaction with the system. The system then asks the user whether they want ALH, CLH, or SLH. The system then plays the prompts for the selected help domain, and then asks the user whether they want to return to the dialogue or get more help in one of the domains.

The two scenarios are exemplified below:

PH access
System: You can send, save, or forward this email. What do you want to do?
User: What do I say now?//What are my options?//
System: Plays PH prompt—a more verbose version of the normal prompt
System: System then asks user whether they want to go back to where they were in the service, or whether they want to go to AH, CH, or SH.
User: PH
System: Plays PH, then offers options again etcetera

AH, CH, and SH access
System: You can send, save, or forward this email. What do you want to do?
User: Help
System: Do you want help with what I just said, with the service you're in, with commands, or do you want the main system help?
User: CH
VOX: Plays CH, then gives menu of choices, et cetera
   Recovery Based on Misrecognition

Recovery in the System is based on a series of prompts; the prompt played is based on the confidence of the utterance received, and the number of recovery prompts that have already been played. We can use the confidence value as the criterion for the ‘entry point’ into error recovery, meaning that we can play different recovery prompts for different confidence values. This is useful to distinguish between when ‘garbage’ is returned from the ASR from when a recognised utterance with a low confidence threshold, and to play different prompts accordingly. The sample dialogue below illustrates how the recovery prompts ‘escalate’ in a scenario where the system repeatedly fails to interpret the user's utterance with sufficiently high confidence to continue the dialogue.
System: What do you want to do with this message?
User: I wanna sand it
System: (M1a) Did you say hear it?
User: No
System: (M2) What do you want to do with this message?
User: Send it.
System: (M3) Sorry, I still didn't hear you clearly. Please try saying only the main words. For example, say ‘send it’.
User: Send the message
System: (M4) Please repeat what you said once more.
User: Send it.
System: (M5) There is still a problem recognising you. If you would like to start again at the beginning, say Vox Hotword; if you would like to go back to the service you were in and try again, say Vox [service]; If you would like to try another service, say Vox and the service you want; or if you would like more Help, say Vox Help.
   Parameter-based Recovery and Confirmations

Parameter confirmations involve the system asking the user to confirm the value they have provided before committing it to the system. These confirmations may be specified in advance, for example in a V-commerce application where it is very important that the value is correct, or may be a result of the dialogue manager's level of confidence that it has interpreted the value correctly. Should the user not confirm the value, it is not committed to the system and the user is reprompted.

Action confirmations have already been referenced in this document, and apply when all parameters in a phrase have a corresponding value. The user is prompted to confirm all the parameters and, if the reply is affirmative, the action is committed. If the user does not confirm the details are correct, then the system will enter ‘parameter editing’ mode.

In parameter editing mode the user is asked which of the parameters values they would like to change, and must refer to the parameter by name. The corresponding parameter value is reset to empty, and the normal system logic continues. Because there is now an empty parameter the system will play the corresponding prompt to elicit a value. An example of an interaction involving parameter editing is provided below:
System: So you'd like to order 12 roses for Lily to be delivered tomorrow?
User: No
System: Would you like to change the flower type, the flower quantity, the recipient name or the delivery date?
User: Can I change Flower type?
System: What type of flowers would you like to send?
User: I'd like to send Lilies
System: So you'd like to order 12 Lilies for Lilly to be delivered tomorrow?
User: Yes
   Optimising Recognition with the SLI

A high level of recognition accuracy is crucial to the success of the system, and this cannot be compromised. Well designed grammars are key to achieving this, but the SLI has features to help provide the best possible accuracy. One aspect of this is the navigation structure described above, which assures that the ASR is only listening for a restricted set of context switches at any time, restricting the number of possible interpretations for utterances and hence increasing the chance of a correct interpretation.

Dynamic Dialogue Flow

In the majority of cases we anticipate that the same set of parameters will need to be elicited in all cases for each phrase. However, on occasion it may be necessary to seek more information based on a parameter value provided by a user. Consider a Flower Booking service in which it is possible to order different types of flowers. Some flower types may have attributes that are not applicable to other flower types that may be ordered—if you order roses there may be a choice of colour, whereas if you order carnations there may not. The dialogue must therefore change dynamically, based on the response the user gives when asked for a flower type. The SLI achieves this by turning off parameters if certain pre-specified values are provided for other parameters in the phrase. Parameters for ALL attributes are associated with the phrase, and are all switched on by default. The parameter values which may be used to switch off particular parameters are specified in advance. In the example given, we would specify that if the ‘flowerType’ parameter is populated with ‘carnations’ then the ‘flowerColour’ parameter should be disabled because there is no choice of colour for carnations.

### Dialogue Manager Operation

The manner in which the Dialogue Manager operates will now be described. The function of the Dialogue Manager is to provide a coherent dialogue with a user, responding intelligently to what the user says, and to responses from applications. To achieve this function it must be able to do the following:

The manner in which the Dialogue Manager operates will now be described. The function of the Dialogue Manager is to provide a coherent dialogue with a user, responding intelligently to what the user says, and to responses from applications. To achieve this function it must be able to do the following:
(i) keep track what the user what the user has said (record state);
(ii) know how to move between dialogue ‘states’;
(iii) know how to communicate with users in different styles;
(iv) know how to interpret some specific expressions to provide standardised input to applications such as times and dates; and
(v) know about the tasks a user is trying to achieve. A dialogue can be further enhanced if the system has some knowledge of the user with whom they are interacting (personalisation).

The next section describes the data structures used to represent workflows, phrases, parameters and prompts, along with an explanation of the demarcation of static and dynamic data to produce a scaleable system. The workflow concept is then described explaining how dialogue flow between phrases and actions is achieved based on conditional logic. The handling and structure of inputs to the system are then considered, followed by key system behaviour including context switching, recovery procedures, firing actions and handling confirmations.

‘Basetypes’ provide a means to apply special processing to inputs where appropriate. Three basetypes, and the way in which they are integrated into the dialogue manager, will be described.

Data Structures and Key Classes

The system classes can be broadly categorised according to whether they are predominantly storage-oriented or function-oriented classes. The function oriented ‘helper’ classes are described later.

The core classes and data structures which are used to play prompts and capture user inputs, and to manage the flow of dialogue will first be described. Much of the data underlying a dialogue session is static, i.e. it does not change during the lifetime of the session. This includes the prompts, the dialogue workflows and the flow components such as phrases and actions.

In the class structure a clear demarcation is made between this data and session-specific data captured during the interaction with the user. This separation means that multiple instances of the Dialogue Manager can share a single core set of static data loaded from the database on start-up. A single server can therefore host multiple dialogue manager sessions without needing to load static data from the database for each new session.

On start-up the static data is loaded into classes that persist between all sessions on that server. For each session new objects are created to represent these concepts; some attributes of these objects are populated from the data held in the ‘static’ classes, whilst others are populated dynamically as the dialogue progresses (session-specific). Note that the Prompt data in the static data store is referenced directly by all sessions; there is no dynamic data associated with a prompt.

Flow Component

A flow component is a workflow object that may be referenced as a point to move to when decisions have to be made regarding dialogue flow. Flow components may be phrases, actions, or other workflows.

The following classes are relevant to the process of loading in-memory data structures for workflow components:
FlowComponentStructure: this is the generic ‘master’ class for flow components, which initialises objects of type Phrase, Action and Worklow based on data read from the database. Because the class only encapsulates this data, and nothing specific to a session, it is ‘static’ and can persist between dialogue manager sessions.
Phrase: this class holds all data for a ‘phrase’ workflow component, including references to a parameter set, the phrase parameters, and to ‘helper classes’ which are used to perform functionality relating to a phrase, such as eliciting data, and editing phrase parameters.
Action: this class represents an abstraction of an action for the dialogue system. Its key attribute is a set of parameters representing values established in the course of the dialogue, which are propagated through this class to the component performing the ‘system’ action.
Workflow: this class represents a workflow; in addition to the core ‘flow’ attributes such as a name and an id, it encapsulates all the functionality needed to manage a workflow. Because it implements the ‘flowComponent’ interface, it may be referenced as a workflow component in its own right. Transitions between workflows are thus straightforward.
   Parameters and Parameter Sets

The following key classes and interfaces are used to manage data relating to parameters: Parameter: interface to classes implemented to store and manage parameters. ParameterImplBase: implements Parameter interface. This class stores parameter attributes, and manages operations on a specific parameter. ParameterSet: interface to classes implemented to store and manage groups of related parameters. BasicParameterSet: implements ParameterSet interface. Holds references to groups of objects implementing ‘parameter’ interface. Manages selecting parameter according to various criteria, applying an operation to all parameters in group, and reporting on status of group of parameters.

Note that some types of parameters require. specialist processing, such as date and time parameters. Such classes are defined to extend the ParameterImplBase class, and encapsulate the additional processing whilst retaining the basic mechanism for accessing and manipulating the parameter data.

Prompts

Prompts are created and shared between sessions; there is no corresponding dynamic per-session version of a prompt. Prompts may contain embedded references to variables, as well as conditional directives. A prompt is stored in the database as a string. The aim of the data structures is to ensure that: as much ‘up-front’ processing as possible is done upon loading state. Because the code to process prompts before they are played is referenced very heavily, it is important that there is no excessive string tokenisation or inefficiencies at this stage, where they can be avoided; and that the code logic for processing embedded directives is abstracted into a well defined and extensible module, rather than being entwined in a multitude of complex string processing.

Data Structures for Prompts

The following is an example of a prompt as it is stored in the prompt database:
I will read you the headlines. After each headline ukann tell meta play-it again, go to the next headline or to read the full story. !switch NUMHEADLINES 1|there%is%one%$CATEGORY%head-line not(1)|there-r%$NUMHEADLINES%$CATEGORY%head-lines !end. Would you like to hear it?

This prompt illustrates an embedded ‘switch’ statement encapsulating a condition. This is resolved dynamically in order to play an appropriate prompt. In the above case: the values for the parameter names referenced (prepended with $) are substituted for resolution. In this case consider that CATEGORY=‘sports’; the text “I will read you the headlines . . . story” is played in all circumstances; the text “there is one sports head line” will be played if the value of the parameter NUMHEADLINES equals ‘1’; the text “there-r 4 sports headlines” will be played if the value of param NUMHEADLINES is 4 (and similarly for other values not equal to 1); and the text “Would you like to hear it” is played under all circumstances”.

The following key structures/classes/concepts underlying prompts are described below.

PromptConstituent:

A prompt is made up of one or more PromptConstituent objects. A prompt constituent is either a sequence of words, or a representation of some conditions under which pre-specified sequences of words will be played. If the ‘varName’ attribute of this object is non-null then this constituent encapsulates a conditional (switch) statement, otherwise it is a simple prompt fragment that does not require dynamic resolution.

PromptCondition:

A prompt condition encapsulates logic dictating under which conditions a particular prompt is played. It contains a match type, a match value (needed for certain match types, such as equality) and a PromptItemList representing the prompt to be played if the condition holds at the time the prompt is referenced.

PromptItem:

A prompt item represents a token in a prompt. This may be either a literal (word) or a reference (variable). The PromptItem class records the type of the item, and the value.

PromptItemList

The core of the PromptItemList class is an array of PromptItems representing a prompt. It includes a ‘build’ method allowing a prompt represented as a string to be transformed into a PromptItemList.

Logic for Prompt Resolution

The process for resolving a prompt is as follows:

Retrieve the prompt from the prompt map

Create a promptBuffer to hold the prompt

For each constituent
If this constituent is a conditional:
   For each condition
      Check whether specified condition holds
      If condition holds, return associated PromptItemList
      Resolve PromptItemList to a string (this may involve substituting values dynamically).
      Append resolved PromptItemList to buffer
Otherwise:
   Resolve PromptItem to a string
   Append resolved PromptItemList to a buffer

Play prompt now held in buffer.

Managing Flow

Dialogue flow occurs as the Dialogue Manager reacts to inputs, either user utterances or notifications from external components. There are two main types of ‘flow’, both ‘intra-phrase’ and ‘inter-phrase’. For inter-phrase transitions, the flow is constrained by a set of static, pre-defined workflows which are read from a database on system start-up. When a ‘flow component’ completes, the system can have one or more next ‘flow components’, each of which has an associated condition. If the condition evaluates to True, then the workflow moves to the associated target. The process will now be described in more detail, and the structure of the data underlying the process.

Branches

The class Branch models a point where a decision needs to be made about how the dialogue should proceed. The attributes of a branch are a base object (the ‘anchor’ of the branch) and a set of objects of class Flowlink. A Flowlink object specifies a condition (a class implementing the ConditionalExpression interface), and an associated destination which is applicable if the condition evaluates to True at the time of evaluation.

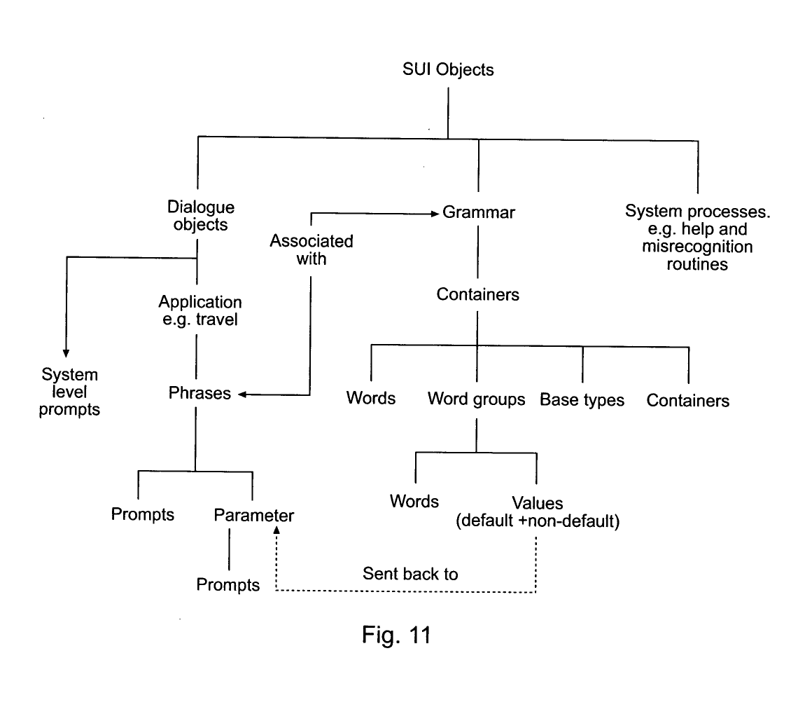

FIG. 11 exemplifies a point in dialogue where the user has specified an option from a choice list of ‘read’, or ‘forward’:

Conditions

Any condition implementing the ConditionalExpression interface may be referenced in a FlowLink object. The current classes implementing this interface are: CompareEquals, CompareGreater, CompareLess, Not, Or, And, True

These classes cover all the branching conditions encountered so far in dialogue scenarios, but the mechanism is extensible such that if new types are required in future it is straightforward to implement these.

Handling Input

Input Structures

Inputs to the Dialogue Manager are either utterances, or notifications from an application manager or other system component. A single input is a set of ‘slots’, associated with a named element. Each slot has both a string and an integer value. For inputs from the ASR the name will correspond to a parameter name, the string value of the associated slot to the value of that parameter, and the integer value a confidence level for that value in that slot.

The following are attributes of the GenericInputStructure class that is extended by the WA VStatus class (for ASR inputs) and by Notification class (for other inputs): private int majorId; private int minorId; private String description; and private HashMap slotMap;

These majorId and minorId attributes of an input are used to determine its categorisation. A major id is a coarse-grained distinction (e.g. is this a notification input, or is it an utterance), whilst a minor id is more fine grained (eg. for an utterance, is this a ‘confirm’ or a ‘reaffirm’ etc.). The slotMap attribute is used to reference all slots pertaining to this input. The following represents the slotMap for an input to the Dialogue Manager from the ASR in response to a user saying “I want to fly to Paris from Milan tomorrow”:

| Key | Value |
|---|---|
| DepartureAirport | Slot {sval: Milan, ival: 40} |
| DestinationAirport | Slot {sval: Paris, ival: 45} |
| DepartureTime | Slot {sval: 4^{th}_November, ival: 51} |

The same structure is used to encapsulate notifications to the dialogue manager.

Handling Input

The key class for handling input is WorkflowManager. This class can effect ‘hotword switching’ as it intercepts all incoming input from the ASR before delegating to the appropriate ‘current’ flow component. There are dedicated methods in the dialogue manager for handling the following input types: OK, CONFIRM, NBEST, ASRERROR, MISUNDERSTOOD.

### Key Dialogue Manager Behaviour

This section describes some key phrase-oriented functionality in the system.

Context Switching

Context switching is achieved using the ‘Hotword’ mechanism. The WorkFlowManager object acts as a filter on inputs, and references a data structure mapping hotwords to flowcomponents. The process simply sets the current active component of the workflow to that referenced for the hotword in the mapping, and dialogue resumes from the new context.

Data Elicitation

The data elicitation process is based around phrases; this section describes the logic underlying the process.

Data Elicitation uses a dedicated ‘helper’ class, DataElicitor, to which a phrase holds a reference. This class can be thought of as representing a ‘state’ into which a phrase flow component can be; it handles playing prompts for eliciting data, ensuring that each parameter in a phrase's parameter set has an opportunity to process the input, and recognising when all parameters have a corresponding value.

Having handled the input, the status of the parameterSet for the phrase is checked; if there are still ‘incomplete’ parameters in the parameter set, then elicitation prompt for the next unfilled parameter is played. If all parameters are complete, then control returns to the current phrase. If a confirmation is required on the phrase before completion then the ‘state’ of the phrase is set to ‘confirmation’, otherwise the phrase component is marked as completed.

Action Complete Confirm/Firing Actions

As described above an ‘Action’ is a flow component. An action object models a system action for the dialogue system, and its key attributes are a set of parameters to work with. An action may be initiated by specifying the action object as the next stage in the dialogue workflow. Note that although in many cases the step following completion of a phrase is to initiate an action, phrases and actions are completely independent objects. Any association between them must be made explicitly with a workflow link.

When the processing of an action is complete, normal workflow logic applies to determine how dialogue flow resumes.

Phrases can be marked as requiring a confirmation stage before an action is initiated. In this case the current ‘state’ of the phrase is set to a confirmation state prior to marking the phrase as complete. The processing defined in this state is to play the ‘confirmation’ prompt associated with the phrase, and to mark the phrase as complete if the user confirms the details recorded. If the user does not confirm the details are correct, the current state of the phrase component becomes ‘SlotEditor’ which enables the user to change previously specified details as described below.

Edit Slots

If the user states that he or she wishes to change the details, the current state for the active phrase component becomes the ‘SlotEditor’ state, whose functionality is defined in the SlotEditor helper class. The SlotEditor is defined as the handler for the current phrase, meaning all inputs received are delegated to this class. In addition, a special ‘dynamic grammar’ is invoked in the ASR which comprises the names of the parameters in the parameterSet associated with the phrase; this allows the user to reference parameters by name when they are asked which they would like to change.

When the user responds with a parameter name, the data elicitation prompt for the parameter is replayed; the user's response is still handled by the SlotEditor, which delegates to the appropriate parameter and handles confirmations if required

Confirmations

The SLI incorporates a ‘confirmation’ state, defined in the Confirmation helper class, that can be used in any situation where the user is required to confirm something. This could include a confirmation as a result of a low-confidence recognition, a confirmation prior to invoking an action, or a confirmation of a specific parameter value. The Confirmation class defines a playPrompt method that is called explicitly on the confirmation object immediately after setting a Confirmation object as a handler for a flow component.

The confirmation class also defines two methods yes and no which define what should occur if either a ‘yes’ or a ‘no’ response is received whilst the confirmation object is handling the inputs. Because these methods, and the playPrompt method are specific to the individual confirmation instances, they are defined when a Confirmation object is declared as exemplified in the following extract:

```
confirmation = new Confirmation( ){
  public void yes( ){
    System.out.println(“Phrase” + Phrase.this.name + “ complete.”);
    controller.flowCompleted(Phrase.this);
  }
  public void no( ){
    setHandler(editor);
    //play edit slot selection prompt
    session.playPrompt(prompts.getPrompt(0, 0,
PromptType.PARAMEDIT_CHOOSEPARAM, PromptStyle.
VERBOSEIMP), properties);
  }
  public void prompt( ){
    //play confirmation prompt
    session.playPrompt(prompts.getPrompt(id.intValue( ), 0,
PromptType.ACTIONCOMPLETE, PromptStyle.VERBOSEIMP),
properties);
  }
```

Confirmation requests driven by low-confidence recognition is achieved by checking the confidence value associated with a slot, and is important in ensuring that an authentic dialogue is maintained (it is analogous to mishearing in a human/human dialogue).

Timer (Help)

The SLI incorporates a mechanism to provide help to the user if it determines that a prompt has been played and no input has been received for a pre-specified period of time. A timer starts when an input is received from the ASR, and the elapsed time is checked periodically whilst waiting for more inputs. If the elapsed time exceeds the pre-configured help threshold then help is provided to the user specific to the current context (state).

Base Types

Base Types are implemented as extensions of the ParameterImplBase class as described in Section 2. These override the processInput method with functionality specific to the base type; the ‘base type’ parameters therefore inherit the generic attributes of a parameter but provide a means to apply extra processing to the input received which relates to a parameter before populating the parameter value.

There are three basetype parameters implemented currently, the behaviour of each is described in the following sections.

State Management in Base Types

A basetype may initiate a dialogue to help elicit the appropriate information; the basetype instance must therefore retain state between user interactions so that it can reconcile all the information provided. It is important that any state that persists in this way is reset once a value has been resolved for the parameter; this ensures consistency if the parameter becomes ‘active’ again (otherwise the basetype may have retained data from an earlier dialogue).

Date

The Date basetype resolves various expressions for specifying a date into a uniform representation. The user may therefore specify dates such as “tomorrow”, “the day before yesterday”, “17^{th} April”, “the day after Christmas” etc, i.e. can specify a date naturally rather than being constrained to use a rigid pre-specified format. Additionally the basetype can respond intelligently to the user if insufficient information is provided to resolve a date expression. For example if the user says “In April” the system should respond “Please specify which day in April”.

The operation of the Date parameter is tightly coupled with the Date grammar; the two components should be viewed as an interoperating pair.

Implementation

The Date basetype establishes whether there is a fully specified ‘reference date’ in the input; it checks whether the input passed to it contains a reference to a day, a month, and optionally a year. If either the month or the day is left unspecified, or is not implied (eg. “this Monday” implies a month), then the user will be prompted for this. It then applies any specified ‘modifiers’ to this ‘reference’ date (eg. “the day after . . .”, or “the week before . . .”, or “a week on . . .”), and populates the parameter value with a standardised representation of the date.

Time

The Time base type resolves utterances specifying times into a standard unambiguous representation. The user say “half past two”, “two thirty”, “fourteen thirty”, “7 o'clock”, “nineteen hundred hours”, “half past midnight” etc. As with the Date basetype, if a time is not completely specified then the user should be prompted to supply the remaining information. The Time basetype is inextricably linked with the Time grammar, which transforms user utterances into a syntax the basetype can work with.

Implementation

The Time basetype tries to derive three values from the input: hour, minute, time period. These are the three attributes which unambiguously specify a time to the granularity required for Vox applications. The basetype first establishes whether there are references to an hour, minutes, time period and ‘time operation’ in the input. The time operation field indicates whether it is necessary to transform the time referenced (e.g. “twenty past three”). If no time period has been referenced, or it is not implicit (“fourteen hundred hours” is implicit) then a flag is set and the user is prompted to specify a time period the next time round, the originally supplied information being retained.

Once the base type has resolved a reference to an hour (with any modifier applied) and a time period then the time is transformed to a standard representation and the parameter value populated.

The following examples illustrate the behaviour of the time base type and the dependency on the time grammar.

Yes/No

This base type encapsulates all the processing that needs to occur to establish whether there was a ‘yes’ or a ‘no’ in a user utterance. This involves switching the grammar to “yes/no” when the parameter becomes active, and extracting the value from the grammar result.

### Dialogue Design

The previous sections have described the nature and function of the voice controller and dialogue manager in detail. The next section discusses the actual generation of dialogue facilitated through the development suite. Much of this will be specific to a given application and so not of particular importance. However, there are a number of areas which are useful to a clear understanding of the present invention.

The Spoken Language Interface is a combination of the hardware, software and data components that allow users to interact with the system though speech. The term “interface” is particularly apt for speech interaction as the SLI acts as a conversational mediator, allowing information to be exchanged between the user and system through speech. In its ideal form, the interface would be invisible and, to the user, the interaction be as seamless and natural as a conversation with another person. The present system aims to approach that ideal state and emulate a conversation between humans.

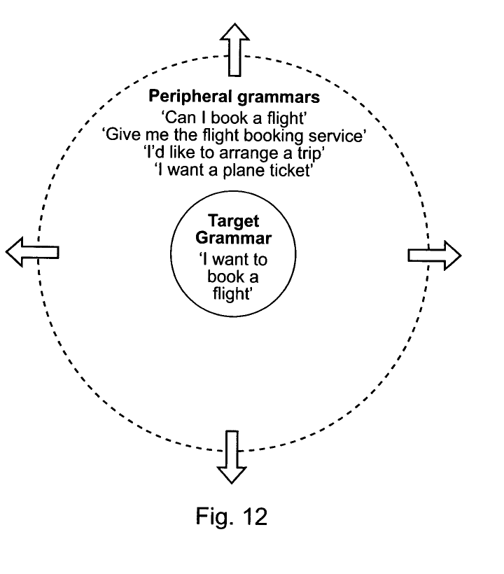

FIG. 12 shows the stages involved in designing a dialogue for an application. There are four main stages: Fundamentals 300, Dialogue 302, Designer 304 and Testing and Validation 306.

The fundamental stage 300 involves defining the fundamental specification for the application, 310. This is a definition of what dialogue is required in terms of the type and extent of the services the system will carry out. An interaction style 312 must be decided on. This style defines the interaction between the system and user and is partly constrained by available technologies. Finally, a house style 314, is defined. This is the characterisation or persona of the system and ensures that the prompt style is consistent.

The Dialogue Style 302 in the design process is to establish a dialogue flow for each service. This comprises two layers 316, 320. In the first layer 316, a dialogue flow maps out the different paths a user may take during their interaction with the system. After this has been done, prompts can be written. Eventually, these will be spoken using Text to Speech (TTS) software. In the second layer 320, help prompts and recovery routines can be designated. The former are prompts which will aid the user if they have problems using the system. The latter are routines which will occur if there is a problem with the interaction from the system's point of view, e.g. a low recognition value.

The Designer Stage 304 implements the first two stages which are essentially a design process. This task itself can be thought of in terms of two sub tasks, coding the dialogue 322 and coding the grammar 324. The former involves coding the dialogue flow and the “Voice” of the system. The latter involves coding the grammar, which can be thought of as the “ears” of the system as it encapsulates everything she is listening out for.

The testing and validation stage 306 involves the testing and validation of the working system. This has two parts. In phases 1 and 2 326, 328 the structure properties of the system are tested at the grammar, phrase and application levels. At phase 3, 330, the system is trialed on human users. This phase identifies potential user responses which have not been anticipated in the grammar. Any errors found will require parts of the system to be rewritten.

Considering now some of these areas in more detail.

Fundamentals—Interaction and House styles.

The interaction style describes the interaction between the user and the system and provides the foundation for the House Style. There are two broad areas on consideration when establishing an interaction style: First, human factors in dialogue design, it is important to make the interaction between the user and system feel natural. Whilst this could be like a human-human interaction, it could also be like a comfortable and intuitive human-computer interaction. Second, limitations in relevant technology; it is important to encourage any interactions that the technology can support. If the speech recognition system can only recognise a small set of individual words then there is no point encouraging users to reply to prompts with long verbose sentences.

The house style describes the recurrent, standardised aspects of the dialogue and it guides the way prompts are written. The house style also embodies the character and, to some extent, the personality of the voice, and helps to define the system environment. The house style follows from the marketing aims and the interaction style.

The house style may comprise a single character or multiple characters. The character may be changed according to the person using the system. Thus, a teenage user may be presented with a voice, style and vocabulary appropriate to a teenager. In the discorse below the character presented to the user is a virtual personal assistant (VPA). It is just one example implementation of a house style. In one embodiment the VPA is friendly and efficient. She is in her early 30's. Her interaction is characterised by the following phrases and techniques:

The VPA mediates the retrieval of information and execution of services. The user asks the VPA for something and the VPA then collects enough relevant information from the user to carry out the task. As such, the user should have the experience that they are interacting with a PA rather than with the specific services themselves.

The VPA refers to the different applications as services, the e-mail service, the travel service, news service etc.

Once the user has gone through the standard password and voice verification checks the VPA says: “Your voice is my command. What do you want to do?” The user can then ask for one of the services using the hot-words “Travel” or “calendar” etc. However, users are not constrained by having to say just the hot-words in isolation, as they are in many other spoken language interfaces. Instead they can say “Will you open the calendar” or “I want to access the travel service” etc.

At the head of each service the VPA tells the user that she has access to the required service. This is done in two ways. For services that are personal to the user such as calendaring she says: “I have your [calendar] open”, or “I have your [e-mail account] open”. For services that are on-line, she says: “I have the [travel service] on-line”. For first time users the VPA then gives a summary of the tasks that can be performed in the particular service. For example, in the cinema guide first time users are given the following information: “I have the cinema guide on-line. You can ask me where and when a particular film is playing, you can hear summaries of the top 10 film releases, or you can ask me what's showing at a particular cinema.” This is followed by the prompt: “What do you want to do?”When a user logs on to the cinema guide for the second time they hear: “I have the cinema guide on-line. What do you want to do?”

Throughout the rest of the service she asks data elicitation questions. When there are no more data elicitation questions to ask she presents relevant information, followed either by a data elicitation question or by asking: “[pause for 3 seconds] What do you want to do?”.

The VPA is decisive and efficient. She never starts phrases with preambles such as Okay, fine, sure etc.).

When the VPA has to collect information from a third party, or check availability; times when the system could potentially be silent for short periods, the VPA tells the user what she is about to do and then says “stand-by”. For example, the VPA might say “Checking availability. Stand-by”.

When the VPA notifies the user of a pending action that will not result in a time lag she uses a prompt with the following structure: [object]0 [action]. For example, message deleted, message forwarded, etc.

When the VPA has to check information with the user, for example, user input information, the VPA says “I understand [you want to fly from London to Paris etc]. Is that correct?”

The prompt style varies through a conversation to increase the feeling of a natural language conversation.

The VPA uses personal pronouns (e.g. I, me) to refer to herself.

The VPA is directive when she asks questions. For example, she would ask: “Do you want to hear this message?” rather than, “Shall I play the message to you?”.

In any service where there is a repetitive routine, such as in the e-mail service where users can hear several messages and have the choice to perform several operations on each message, users are given a list of tasks (options) the first time they cycle through the routine. Thereafter they are given a shorter prompt. For example, in the message routine users may hear the following: message 1 [headed], prompt (with options), message 2 [headed], prompt (without options), message 3 [headed], prompt (without options), etc. The VPA informs the user of their choices by saying “You can [listen to your new messages, go to the next message, etc]”.

The system is precise, and as such pays close attention to detail. This allows the user to be vague initially because the VPA will gather all relevant information. It also allows the user to adopt a language style which is natural and unforced. Thus the system is conversational.

The user can return to the top of the system at any time by saying [service name or Restart].

The user can make use of a set of hot-word navigation commands at any time throughout the dialogue. These navigation commands are: Help, Repeat, Restart, Pause, Resume, Cancel, Exit. Users can activate these commands by prefixing them with the word Vox, for example, Vox Pause. The system will also respond to natural language equivalents of these commands.

The house style conveys different personalities and determines, to a certain extent, how the prompts sound. Another important determinant of the sound of the prompts is whether they are written for text to speech conversion (TTS) and presentation, human voice and TTS, a synthesis of human voice fragments, or a combination of all three methods.

### Creating Dialogues and Grammars

SLI objects are the building blocks of the system. They are designed with the intention of providing reusable units (eg recurrent patterns in the dialogue flow or structures used in the design) which could be used to save time and ensure consistency in the design of human/computer dialogue systems. FIG. 11 shows the relationship between various SLI objects.

Dialogue Objects

Dialogue objects are necessary components for design of interaction between the system and the user as they determine the structure of the discourse in terms of what the system will say to the user and under which circumstances. The dialogue objects used are applications, phrases, parameters, and finally prompts and system prompts.

An application defines a particular domain in which the user can perform a multitude of tasks. Examples of applications are; a travel service in which the user can carry out booking operations, or a messaging service in which the user can read and send e-mail. An application is made up of a set of phrases and their associated grammars. Navigation between phrases is carried out by the application manager.

A phrase can be defined as a dialogue action (DA) which ends in a single system action (SA). As shown in examples 1-3, a DA can consist of a series of prompts and user responses; a conversation between the system and the user, as shown in example one, or a single prompt from the system (example two). A SA can be a simple action such as retrieving information from a database (example three) or interacting with a service to book a flight.

Example One: Flight Booking

DA: Lengthy dialogue between system and user to gather flight information
SA: Book flight
   Example Two: Cinema
DA: Systems tells user there are no cinemas showing the film they want to see.
SA: Move onto the next prompt
   Example Three: Contacts
DA: Dialogue between system and user to establish the name of a contact
SA: Check if contact exists in user's address book.

Phrases are reusable within an application, however they must be re-used in their entirety, it is not possible to re-enter a phrase halfway through a dialogue flow. A phrase consists of parameters and prompts and has associated grammar.

A parameter is a named slot which needs to be filled with a value before the system can carry out an action. This value depends on what the user says, so is returned from the grammar. An example of a parameter is ‘FLIGHT_DEST’ in the travel application which requires the name of an airport as its value.

Prompts are the means by which the system communicates or ‘speaks’ with the user. Prompts serve several different functions. Generally, however, they can be divided into three main categories: phrase level prompts, parameter level prompts and system level prompts. These are defined as follows:

Parameter level prompts—Parameter level prompts comprise everything the system says in the process of filling a particular parameter. The principle dialogue tasks involved in this are eliciting data from the user and confirming that the user input is correctly understood. Examples of parameter level prompts are the Parameter Confirm prompt and the Parameter Reaffirm prompt.

Phrase level prompts—Phrase level prompts comprise everything the system says in order to guide a user through a phrase and to confirm at the end of a phrase that all data the user has given is correctly understood. Examples of phrase level prompts are Entry Prompts and Action Complete Confirm Prompts.

System Prompts—System prompts are not attached to a particular phrase or parameter in an application. This means they are read out regardless of the phrase the user is currently in. Examples of system prompts are the ‘misunderstood once/twice/final’ which play if the system cannot interpret what the user is saying.

Grammar objects are the building blocks of the grammar which the ASR uses to recognise and attach semantic meaning to user responses. Instances of grammar objects are: containers, word groups and words, base types, values and hot words.

Containers are used to represent groups of potential user utterances. An utterance is any continuous period of speech from the user. Utterances are not necessarily sentences and in some cases consist purely of single word responses. Utterances are represented in the container by strings. Strings comprise a combination of one or more word groups, words, base types and containers adjacent to one another. It is intended that there will be a string in the grammar for every possible user response to each Prompt.

Word groups can contain single words or combinations of single words. E.g. ‘flight’ can be a member of a word group, as can ‘I want to book a’. The members of a word group generally have a common semantic theme. For example, a word group expressing the idea that a user wants to do something, may contain the strings ‘I want to’ and ‘I would like to’.

Those word groups which carry the most salient information in a sentence have values attached to them. These word groups are then associated with a parameter which is filled by that value whenever a member of these word groups is recognised by the ASR. Example one is a typical grammar string found in the travel application.
Example one: ‘I want to book a flight to Paris’
   The word group containing the most salient word ‘Paris’ is marked as having to return a value to the associated parameter ‘TO_DESTINATION’. In the case of hearing example one the value returned is ‘Paris’.

Base type objects are parameter objects which have predefined global grammars, i.e. they can be used in all applications without needing to re-specify the grammar or the values it returns. Base types have a special functionality included at dialogue level which other containers or phrase grammars do not have. For example, if a user says ‘I want to fly at 2.00’.

They will be moved into the database so they can be edited but with caution as the back end has pre-set functions which prompt the user for missing information and which rely on certain values coming back.

An example of this is the ‘Yes/No’ base type. This comprises a Yes/No parameter which is filled by values returned from a mini-grammar which encapsulates all possible ways in which the user could say yes or no.

Parameters are filled by values which are returned from the grammar. It is these values which determine the subsequent phrase or action in the dialogue flow. Parameters are filled via association with semantically salient word groups. This association can be specified as a default or non-default value.

A default value occurs when an individual member of a word group returns itself as a value. For example, in the travel application, the parameter ‘Airport’ needs to be filled with directly with one of the members of the word group Airports, for example ‘Paris’ or ‘Rome.’ This is known as filling a parameter with the default value.

This method should be used when the members of a word group belong to the same semantic family (e.g. they are all airports), but the semantic differences between them are large enough to have an impact on the flow of the system (e.g. they are different airports).

A non default Value occurs when a whole word group returns single value. This is generally used when a parameter can be filled with one of many possible values. For example, in the ‘Memo’ application the parameter ‘MEMO_FUNCTION’ is used by the back end to specify whether the user should listen to a saved memo or record a new one. To accommodate this the word group containing all the synonyms of ‘listen to a saved memo’ sends back a single value ‘saved_memo,’ whereas the word group containing all the synonyms of ‘record a new memo’ sends back a single value ‘new_memo’.

This method is used when the members of a word group belong to the same semantic family (e.g. they all express the user wants to listen to a new memo) but the semantic differences between members are is inconsequential (i.e. they are synonyms)

Hot words allow system navigation, and are a finite word group which allows the user to move around more easily. The two main functions carried out by hot words are application switching and general system navigation. In a preferred embodiment, Hot words always begin with the word Vox to distinguish them from the active phrase grammar.

General navigation hot words perform functions such as pausing, cancelling, jumping from one service to another, and exiting the system. The complete set is as follows.
Help: Takes the user to the Vox help system
Pause: Pauses the system
Repeat: Repeats the last non-help prompt played
Cancel: Wipes out any action carried out in the current phrase and goes back to the beginning of the phrase
Restart: Goes back to the beginning of the current service
Resume: Ends the pausing function
Vox [name of service]: Takes the user to the service they ask for. If the user has left a service midway, this hot word will return them to their point of departure
Exit: Exits the system

Application switching hot words are made up of the Vox' key word followed by the name of the application in question, e.g. ‘Vox Travel’. These allow the system to jump from one application to another. For example, if the user is in cinema booking and needs to check their calendar they can switch to the calendar application by saying ‘Vox Calendar’. Hot words only allow the user to jump to the top of another application, for example if a user is in e-mail and wants to book a flight they cannot do this directly without saying ‘Vox travel’ followed by ‘I want the flight booking service’. Ability to switch on an inter-phrase level is under development for future releases. These are a subset of the general registration hot words.

SLI system processes are dialogues which temporarily defer from the default dialogue flow. They exist across applications and are triggered under certain conditions specified at the system level. Like all other dialogues, they are made up from SLI objects, however, they differ in that they exist across applications and are triggered by conditions specified at system level. Examples of SLI System processes are the help and misrecognition routines.

One of the features that distinguishes aspects of the present invention over the prior art is a dialogue design that creates an experience that is intuitive and enjoyable. The aim is to give the user the feeling that they are engaging in a natural dialogue. In order for this to be achieved it is necessary first to anticipate all the potential responses a user might produce when using the system, and secondly to ensure that all the data that has been identified is installed in the development tool. The role of the grammar is to provide structure in which we can contain these likely user responses. This section considers the processes involved in constructing one of these grammars in the development tool.

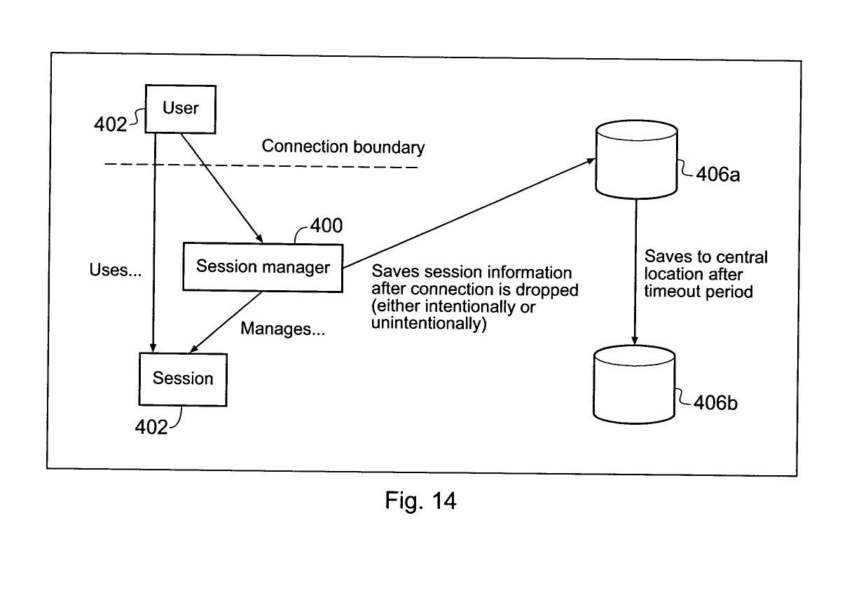

The system is designed so that users are not constrained into responding with a terse utterance only. They do, however, encourage a particular response from the user. This response is known as the ‘Target Grammar’. Yet the system also allows for the fact that the user may not produce this target grammar, and houses thousands of other potential responses called ‘Peripheral Grammars’. The relationship between these is shown in FIG. 14.

Before any data can be inserted into the grammar, it is first necessary to make a record of all the potential responses a user could produce at each point in the system. The responses can be predicted if we use some basic syntactical rules as our framework. Thus, if a user issues a demand, there are four different ways this is likely to be expressed structurally:

Telegraphic: A simple one or two word utterance expressing the desired action or service only, such as ‘Flight booking’, ‘Air travel’ etc.

Imperative: A concise form with no explicit subject, such as ‘Book a flight’; ‘Get me a flight’ etc.

Declarative: A simple statement, such as ‘I want to book a flight’; ‘I need the travel service’ etc.

Interrogative: A question form, such as ‘Can I book a flight?’; ‘Can you get me a flight?’etc.

Once these basic forms have been identified, they can be expanded upon to incorporate the various synonyms at each point (‘could’ for ‘can’, ‘arrange’ for ‘book’ etc.). These lists of words will form the basis for the words, word groups and containers in the grammar.

### Other Components

The previous discussion has centred on the components of the speech user interface and the manner in which the system interfaces with users.

Session Manager

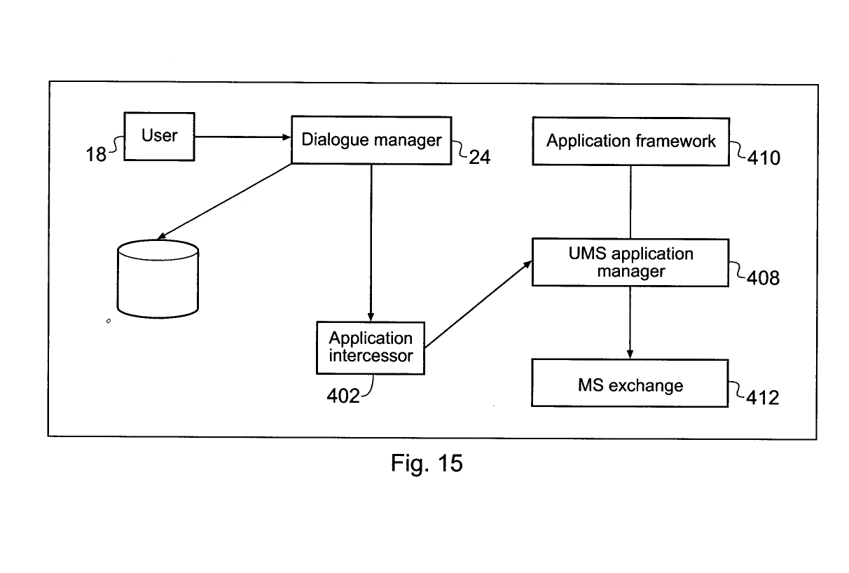

There are two ways a user can communicate with the system; interactively and non-interactively. By interactive we mean any communication which requires the user to be online with the system, such as Voice, Web or Wap. By non-interactive we mean any communication which is conducted offline, such as by email. Whenever a user communicates interactively with the system, usually via voice, a session is allocated to deal with the user. A session is essentially a logical snapshot of what tasks the user is running and how far they are in completing each of those tasks. The duration of a session lasts from when the user first logs on and authenticates to when they terminate the communication. The component which deals with the allocation, monitoring and management of session is the Session Manager (SM). Referring to FIG. 15, the Session Manager 400 is shown managing a plurality of user sessions 402.

The Session Manager additionally performs the tasks of authentications and saving session information. When a user 18 first dials into the system and a Voice Controller 19 has successfully brokered the resource to support the user, the SM 400 is contacted to find an available session. Before the SM can do that, it must first authenticate the user by identifying the person as a registered user of the system and determining that the person is who they say they are.

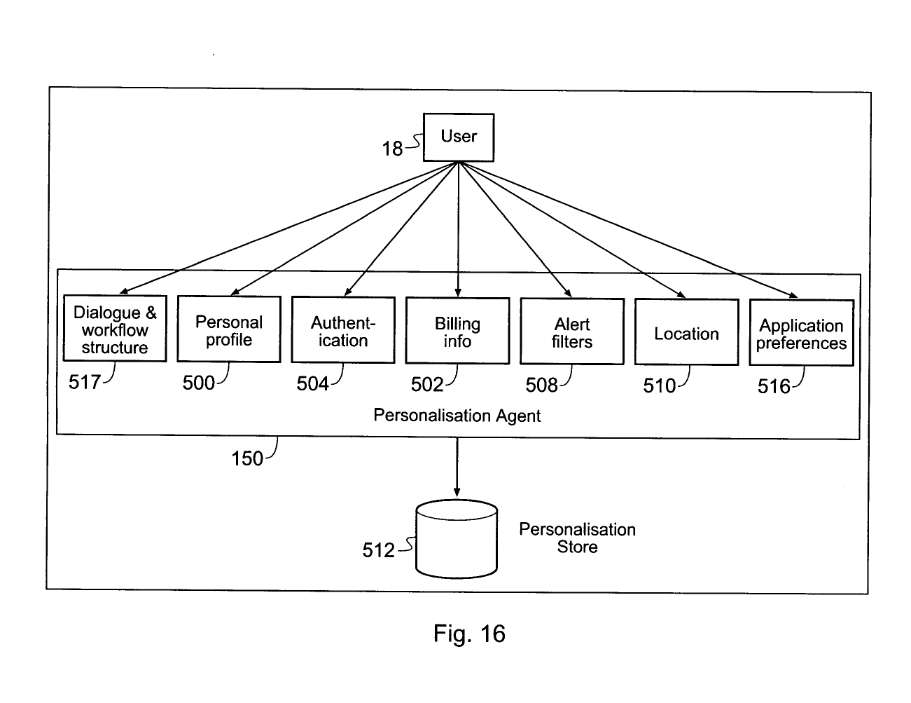

When a user goes offline it is important that their session information is saved in a permanent location so that when they next log in, the system knows what tasks they have outstanding and can recreate the session for them if the user requests it. For example, let's say a user is on the train, has dialled into the system via their mobile phone, and is in the middle of a number of tasks (such as booking a flight and composing an email). The train goes through a tunnel and the phone connection is lost. After exiting the tunnel and dialing back into the system, the user would then expect to be returned to the position they were at just before the call was dropped. The other situation where saving session information may be important is to improve performance. When a user is online, holding all their session information in an active state can be a drain on computer resources in the DM. Therefore, it may become necessary to cache session information or not to have stateful sessions at all (that is read or write session information from a repository as necessary). This functionality is achieved by a relational database 406 or equivalent at the backend of the Session Manager 400 (FIG. 16). The Session Manager could then save the session information to the database when needed.

One of the main technical challenges is to have the session saving/retrieval process run at an acceptable performance level, given that the system will be distributed across different locations. For example, a user in the middle of a session but has to stop to get on a flight to another country. On arrival, they then dial back into the system. The time taken that to locate that user's last session information should be minimised as much as possible, otherwise they will experience a delay before they can start using the system. This may be achieved by session information saved to the local system distribution (the location the user last interacted with). After a set timeout period, the user's session information would then be moved to a central location. So, when the user next dials in, the system only needs to look into the current local distribution and then the central location for possible session information, thus reducing the lookup time.

Notification Manager

The fulfilment of tasks initiated by the Dialog Manager takes place independently and in parallel to the Dialog Manager executing dialogs. Similarly some of the Application Managers may generate events either through external actions or internal housekeeping, examples of such events include: a message being received by an email application manager, changed appointment details. This is non-interactive communication and because of this there needs to be a way for these sorts of event to be drawn to the attention of the user, whether they are on-line or off-line.

The Notification Manager shields the complexity of how a user is notified from the Application Managers and other system components that generate events that require user attention. If the user is currently on-line, in conversation with the DM, the Notification Manager system brings the event to the notification of the DM so that it can either resume a previously started dialogue or initiate a new dialogue. If the user is not on-line then the NM initiates the sending of an appropriate notification to the user via the user's previously selected preferred communications route and primes the Session Manager (SM) so that when the user connects, the SM can initiate an appropriate dialogue via the DM.

Application Manager

For each external service integrated with the system, an Application Manager 402 (AM) is created. An AM is an internal representation of the service and can include customised business logic. For example, an emailing service may be implemented by a Microsoft Exchange server from Microsoft Corp. When a user sends an email, the system will be calling a “send email” function provided by that particular Application Manager, which will in turn make a call on the Exchange Server. Thus, if any extra business logic is required, for example, checking whether the email address is formed correctly, it can be included in the Application Manager component.

This functionality is illustrated in FIG. 17. A user 18 says to the system “send email”. This is interpreted by the Dialogue Manager 24 which will invoke the command in the relevant application manager. An application intercessor 402 routes the command to the correct application manager. The application manager causes an email to be sent by MS Exchange 412.

When a new Application Manager is added to the system, several things occur: The Application Manager Component is installed and registered on one or more Application Servers; The rest of the system is then notified of the existence of the New Application Manager by adding an entry to a global naming list, which can be queried at anytime. The entry in the list also records the version identifier of the application.

A similar process is involved for removing or modifying an exiting Application Manager component. Updates to Application Manager Functionality or the dialogue script can be tracked using the version identifiers. This allows a fully active service to be maintained even when changes are made more than one version of an AM (or its script) can be run in parallel within the system at any time.

Transaction Logging

It is vital that business transactions undertaken by users are recorded as this records revenue. A business transaction can be anything from sending an email to booking a flight. The system requires transactional features including commit, abort and rollback mechanisms. For example, a user could be going through a flight booking in the system. At the last moment something occurs to them and they realise they can't take the flight so they say, “Cancel flight booking”. The system must then abort the entire flight booking transaction, and roll back any changes that have been made.

An application intercessor is used which acts as the communication point between the application manager subsystems and the dialogue manager. Every command that a user of an Application Manager issues via the dialogue manager is sent to the application intercessor first. The intercessor then in turn routes the message to the appropriate application manager to deal with. The intercessor is a convenient place for managing transactional activities such as begin a transaction, rollback etc. to be performed. It also give a powerful layer of abstraction between the dialogue manager and application manager subsystems. This means that adding an application manager to cope with a new application does not require modification of any part of the system.

Personalisation/Adaptive Learning Subsystem

It is important to provide an effective, rewarding voice experience to end users. One of the best means of achieving this is to provide a highly personal service to users. This goes beyond allowing a user to customise their interaction with the system; it extends to a sophisticated voice interface which learns and adapts to each user. The Personalisation/Adaptive Learning Subsystem is responsible for this task the two main components of which are the Personalised Agent (54, FIG. 4) and the Adaptive Learning agent (33, FIG. 4).

The functions of the Personalisation Agent are shown in FIG. 18. The Personalisation Agent 150 is responsible for: Personal Profile 500 (personal information, contact information etc); Billing Information 502 (Bank account, credit card details etc); authentication information 504 (username, password); application preferences 506 (“Notify me of certain stock price movements from the Bloomberg Alert Application”); Alert Fillers 508 (Configure which messages are notified to the user and in which format—SMS; Email etc); Location 510 (in the office; in a meeting; in the golf course etc); Application Preferences 516 (Frequent flyer numbers, preferred seating, favourite cinema, etc); and Dialogue & Workflow Structure Tailoring 517 (results of the Adaptive Learning Agent tuning the SLI components for this user). All this information is held in a personalisation store 512 which the personalisation agent can access.

It is the user and the adaptive learning agent who drives the behaviour of the personalisation agent. The personalisation agent is responsible for applying personalisation and the adaptive learning agent or user is responsible for setting parameters etc.

The main interface for the user to make changes is provided by a web site using standard web technology; html, javascript, etc. on the client and some serve side functionality (eg java server pages) to interface with a backend database. Although, the user can also update their profile settings through the SLI.

The adaptive learning agent can make changes to the SLI components for each user or across groups of users according to the principles laid out earlier.

Location Manager

The Location Manager uses geographic data to modify tasks so they reflect a user's currently specified location. The LM uses various means to gather geographic data and information to determine where a user is currently or where a user wants information about. For example: asking the user, cell triangulation (if user is using a mobile phone), Caller Line Identification (extracting the area code or comparing the full number to a list of numbers stored for the user), application level information (user has an appoointment in their diary at a specified location) and profile information. The effect of this service is to change the frame of reference for a user so that requests for say restaurants, travel etc. are given a relevant geographic context, without the user having to restate the geographical context for each individual request.

Advertising

Some consider audio advertising intrusive, so the types and ways in which advertising is delivered may be varied. The system is able to individually or globally override any or all of the following options:
(i) A user can opt to not receive any advertising.
(ii) A user can opt for relevant advertising prompts. For example, a user is booking a flight to Paris; the system can ask if the user wants to hear current offers on travel etc. to Paris.
(iii) A user can opt for relevant topical advertisements. For BA currently flies to 220 destinations in Europe”.
(iv) A user can select to receive general advertisements so that while they are on hold or waiting they receive advertisements similar to radio commercials.

While an advertisement is being played, the user can be given options such as: Interrupt; Put on-hold/save for later playback, Follow up (e.g. if an advert is linked to a v.commerce application provided by the system),

Movie theatres, restaurant chains, etc. can sponsor content. Some examples: When a user requests information on a specific movie, the user could hear “Movie information brought to you by Paradise Cinemas”. A user can request information about an Egon Ronay listed restaurant. The Advertising Service sources material from third parties, the on-demand streaming of advertisements over the Internet from advertising providers may provide to be unsatisfactory, and therefore it will be necessary to allow for the local caching of advertisements so as to ensure a consistent quality of service is delivered.

Although the invention has been described in relation to one or more mechanism, interface and/or system, those skilled in the art will realise that any one or more such mechanism, interface and/or system, or any component thereof, may be implemented using one or more of hardware, firmware and/or software. Such mechanisms, interfaces and/or systems may, for example, form part of a distributed mechanism, interface and/or system providing functionality at a plurality of different physical locations. Furthermore, those skilled in the art will realise that an application that can accept input derived from audio, spoken and/or voice, may be composed of one or more of hardware, firmware and/or software.

Insofar as embodiments of the invention described above are implementable, at least in part, using a software-controlled programmable processing device such as a Digital Signal Processor, microprocessor, other processing devices, data processing apparatus or computer system, it will be appreciated that a computer program for configuring a programmable device, apparatus or system to implement the foregoing described methods is envisaged as an aspect of the present invention. The computer program may be embodied as source code and undergo compilation for implementation on a processing device, apparatus or system, or may be embodied as object code, for example. The skilled person would readily understand that the term computer system in its most general sense encompasses programmable devices such as referred to above, and data processing apparatus and firmware embodied equivalents.

Software components may be implemented as plug-ins, modules and/or objects, for example, and may be provided as a computer program stored on a carrier medium in machine or device readable form. Such a computer program may be stored, for example, in solid-state memory, magnetic memory such as disc or tape, optically or magneto-optically readable memory, such as compact disc read-only or read-write memory (CD-ROM, CD-RW), digital versatile disc (DVD) etc., and the processing device utilises the program or a part thereof to configure it for operation. The computer program may be supplied from a remote source embodied in a communications medium such as an electronic signal, radio frequency carrier wave or optical carrier wave. Such carrier media are also envisaged as aspects of the present invention.

Although the invention has been described in relation to the preceding example embodiments, it will be understood by those skilled in the art that the invention is not limited thereto, and that many variations are possible falling within the scope of the invention. For example, methods for performing operations in accordance with any one or combination of the embodiments and aspects described herein are intended to fall within the scope of the invention. As another example, those skilled in the art will understand that any voice communication link between a user and a mechanism, interface and/or system according to aspects of the invention may be implemented using any available mechanisms, including mechanisms using of one or more of: wired, WWW, LAN, Internet, WAN, wireless, optical, satellite, TV, cable, microwave, telephone, cellular etc. The voice communication link may also be a secure link. For example, the voice communication link can be a secure link created over the Internet using Public Cryptographic key Encryption techniques or as an SSL link. Embodiments of the invention may also employ voice recognition techniques for identifying a user.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features and sub-features from the claims may be combined with those of any other of the claims in any appropriate manner and not merely in the specific combinations enumerated in the claims.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A spoken language interface mechanism for enabling a user to provide spoken input to at least one computer implementable application, the spoken language interface mechanism comprising:
an automatic speech recognition (ASR) mechanism operable to recognise spoken input from a user and to provide information corresponding to a recognised spoken term to a control mechanism, said control mechanism being operable to determine whether said information is to be used as input to a current context, and conditional on said information being determined to be input for said current context, to provide said information to said current context, wherein said control mechanism is further operable to switch context conditional on said information being determined not to be input for said current context.

2. A spoken language interface mechanism according to claim 1, further comprising a speech generation mechanism for converting at least part of any output to speech.

3. A spoken language interface mechanism according to claim 1, further comprising a session management mechanism operable to track the user's progress when performing one or more tasks.

4. The spoken language interface mechanism of claim 3, wherein the session management mechanism is operable to track one or more reached position when one or more said tasks and/or dialogues are being performed and subsequently to reconnect the user at one said reached position.

5. A spoken language interface mechanism according to claim 1, further comprising an adaptive learning mechanism operable to personalise a response of the spoken language interface mechanism according to the user.

6. A spoken language interface mechanism according to claim 1, further comprising an application management mechanism operable to integrate external services with the spoken language interface mechanism.

7. A spoken language interface mechanism according to claim 1, wherein at least one said application is a software application.

8. A spoken language interface mechanism according to claim 1, wherein at least one of the automatic speech recognition mechanism and the control mechanism are implemented by computer software.

9. A spoken language interface according to claim 1, wherein the control mechanism is operable to provide said information to said at least one application when non-directed dialogue is provided as spoken input from a user.

10. A spoken language interface mechanism according to claim 1, further comprising a notification manager.

11. A computer system including the spoken language interface mechanism according to claim 1.

12. A program element including program code operable to implement the spoken language interface mechanism according to claim 1.

13. A computer program product on a carrier medium, said computer program product including the program element of claim 12.

14. A computer program product on a carrier medium, said computer program product including program code operable to provide a control mechanism operable to provide recognised spoken input recognised by an automatic speech recognition mechanism as an input to a current context, conditional on said spoken input being determined to be input for said current context, and further operable to switch context conditional on said information being determined not to be input for said current context.

15. A computer program product according to claim 14, wherein the control mechanism is operable to provide said information to at least one application when non-directed dialogue is provided as spoken input from a user.

16. A computer program product according to claim 14, wherein the carrier medium includes at least one of the following set of media: a radio-frequency signal, an optical signal, an electronic signal, a magnetic disc or tape, solid-state memory, an optical disc, a magneto-optical disc, a compact disc and a digital versatile disc.

17. A spoken language system for enabling a user to provide spoken input to at least one application operating on at least one computer system, the spoken language system comprising:
an automatic speech recognition (ASR) mechanism operable to recognise spoken input from a user; and
a control mechanism configured to provide to a current context spoken input recognised by the automatic speech recognition mechanism and determined by said control mechanism as being input for said current context, wherein said control mechanism is further operable to switch context conditional that said spoken input is determined not to be input for said current context.

18. A spoken language system according to claim 17, wherein the control mechanism is operable to provide said spoken input recognised by the ASR to said at least one application when non-directed dialogue is provided as spoken input from a user.

19. A spoken language system according to claim 17, further comprising a speech generation mechanism for converting at least part of any output to speech.

20. A method for providing user input to at least one application, comprising the steps of:
configuring an automatic speech recognition mechanism to receive spoken input;
operating the automatic speech recognition mechanism to recognise spoken input; and
providing to a current context spoken input determined as being input for said current context, or switching context conditional on said spoken input being determined not to be input for said current context.

21. A method according to claim 20, wherein the provision of the recognised spoken input to said at least one application is not conditional upon the spoken input following a directed dialogue path.

22. A method of providing user input according to claim 20, further comprising the step of converting at least part of any output to speech.

23. A method of providing user input according to claim 20, further comprising the step of:
tracking one or more reached position of the user when performing one or more tasks and/or dialogues.

24. The method of claim 23, further comprising the step of subsequently reconnecting the user to a task or dialogue at one said reached position.

25. A development tool for creating components of a spoken language interface mechanism for enabling a user to provide spoken input to at least one computer implementable application, said development tool comprising an application design tool operable to create at least one dialogue defining how a user is to interact with the spoken language interface mechanism, said dialogue comprising one or more inter-linked nodes each representing an action, wherein at least one said node has one or more associated parameter that is dynamically modifiable while the user is interacting with the spoken language interface mechanism.

26. A development tool according to claim 25, wherein the action includes one or more of an input event, an output action, a wait state, a process and a system event.

27. A development tool according to claim 25, wherein the application design tool provides said one or more associated parameter with an initial default value or plurality of default values.

28. A development tool according to claim 25, wherein said one or more associated parameter is dynamically modifiable in dependence upon the historical state of the said one or more associated parameter and/or any other dynamically modifiable parameter.

29. A development tool according to claim 25, further comprising a grammar design tool operable to provide a grammar in a format that is independent of the syntax used by at least one automatic speech recognition system.

30. A development suite comprising a development tool according to claim 25
